(19) United States
(12) Patent Application Publication
(10) Pub. No.: US 2022/0414718 A1
(43) Pub. Date: Dec. 29, 2022

(54) AUTOMATED PROVISIONING FOR MANAGING OF CONVERSATIONS ACROSS SERVICE DELIVERY NETWORKS

(71) Applicant: M3G Technology, Inc., San Francisco, CA (US)

(72) Inventors: Douglas E. Marinaro, Santa Clara, CA (US); Aviraj B. Singh, Brooklyn, NY (US); Patrick John Banta, San Rafael, CA (US)

(21) Appl. No.: 17/850,679

(22) Filed: Jun. 27, 2022

Related U.S. Application Data
(60) Provisional application No. 63/215,362, filed on Jun. 25, 2021.

(51) Int. Cl. G06Q 30/02; G06Q 50/00; H04L 51/18; H04L 51/046; H04L 51/58

(52) U.S. Cl. CPC G06Q 30/0281; G06Q 50/01; H04L 51/18; H04L 51/046; H04L 51/58; H04L 51/02

(57) ABSTRACT

A method for establishing at least three-way conversations between customers, service providers, and brand agents within a service delivery network (SDN) is provided. The method commences with receiving a request from a customer for a service by a brand and collecting metadata associated with the customer. The method continues with receiving identification data associated with a service provider. The service provider is selected by the brand based on at least the metadata. The method further includes initiating a two-way communication channel between the customer and one or more brand agents associated with the brand. The method further includes providing a Uniform Resource Locator to the service provider to join the two-way communication channel. The method further includes initiating an at least three-way conversation between the customer, the service provider, and the one or more brand agents via the two-way communication channel.

### CROSS-REFERENCE TO RELATED APPLICATIONS

The present application claims priority of U.S. Provisional Patent Application No. 63/215,362 filed on Jun. 25, 2021, entitled “Automated Provisioning for Managing of Conversations across Service Delivery Networks,” which is incorporated herein by reference in its entirety for all purposes.

### TECHNICAL FIELD

The present disclosure generally relates to systems and methods for automated provisioning and managing of conversations between customers, brands, and providers across service delivery networks.

### BACKGROUND

Businesses and other organizations that provide services, such as nonprofit organizations and government agencies, often rely on conversations with their customers before, during, and after the service delivery to ensure the services they provide are delivered correctly and to the customer's satisfaction. The trend of having these conversations online rather than in person has accelerated dramatically in recent times due to the pandemic, changes in work environment, and changes in consumer behavior. Customers expect to engage their service provider through an instant messaging channel at any time instead of adding a new application with a new account. Businesses may cooperate with other businesses to provide products or services to a set of customers. This cooperation may be informal relationships such as a local auto repair shop cooperating with a local auto body shop and referring customers to each other. This cooperation may also be formal such as an online marketplace business where customers who visit a website of the online marketplace business can search, select, and book appointments at thousands of auto repair shops or an on-demand delivery service business where customer orders placed with hundreds of merchants are delivered by thousands of independent gig workers.

The experience from a customer's perspective is termed a Service Delivery Network (SDN) and defined as when two or more organizations, in the customer's eyes, are responsible for the provision of a connected overall service experience (Tax, S et al. “The Service Delivery Network (SDN) A Customer-Centric Perspective of the Customer Journey”, October 2013, J. Ser. Res. 16(4):454-470).

This organization of businesses may also be described as a business ecosystem. A business ecosystem is a purposeful arrangement between two or more entities (the members) to create and share value for a collective set of customers.

Typically, one of the organizations of the two or more organizations that are responsible for the delivery of products or service to an individual or business is viewed by the customer or the other organizations as leading or orchestrating. In business ecosystems, this role is termed the orchestrator and, in this disclosure, referred to as brand. The employees or authorized contractors within the brand are referred to as agents or brand agents. The other organizations that are orchestrated or lead by the brand and are responsible for the delivery of the product or service are referred to as providers or service providers, and individuals or businesses, which receive a product or service, are referred to as customers. Collectively, the brand and the providers that the brand orchestrates to deliver products or services to customers is referred to as the SDN.

When two or more organizations are responsible for delivery of the service to an individual or business, breakdowns in communications can occur that may result in delays or improper delivery of the product or service, leading to lost opportunity, customer dissatisfaction, lost business, and additional costs. It can be difficult for the brand to ensure that all providers communicate consistently with their customers during the product or service delivery experience. The customer may initially communicate with the brand or brand's systems, which must hand-off communication to the one or more providers who often must communicate directly with the customer to deliver the product or service.

Many customers prefer to communicate via widely used instant messaging communication channels, such as Short Message Service (SMS) and Multimedia Messaging Service (MMS) text messages. While existing business group text messaging enables all the employees or authorized contractors within one business entity to communicate as a group with a single customer in one conversation over a single shared communication channel, it does not provide a method or process for other businesses to join the same conversation and engage with the same customer over the single shared communication channel.

Moreover, for the brand orchestrating an SDN with a large and ever-changing ecosystem of providers, having each of the providers install an application associated with the brand on their user devices can be unrealistic. Instead, an ad hoc method or process of enabling a provider to join the conversation is needed.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

According to one example embodiment of the present disclosure, a system for establishing at least three-way conversations between customers, service providers, and brand agents within the SDN is provided. The system may include a processor and a memory storing instructions to be executed by the processor. The processor may be configured to receive a request from a customer for a service by a brand. The processor may be further configured to collect metadata associated with the customer. Upon receiving the metadata and the request from the brand, the processor may receive identification data associated with a service provider. The service provider may be selected by the brand based on the metadata. The processor may be configured to initiate a two-way communication channel between the customer and one or more brand agents. The processor may be configured to provide, based on the identification data, a Uniform Resource Locator (URL) to the service provider to invite the service provider to join the two-way communication channel. Opening the URL by the service provider may result in establishing an at least three-way conversation between the customer, the service provider, and the one or more brand agents.

According to another embodiment of the present disclosure, a method for establishing at least three-way conversations between customers, service providers, and brand agents within an SDN is provided. The method may commence with receiving a request from a customer for a service by a brand. The method may then continue with collecting metadata associated with the customer. Upon receiving the request and the metadata from the brand, the method may continue with receiving identification data associated with a service provider. The service provider may be selected by the brand based on the metadata. The method may further include initiating a two-way communication channel between the customer and one or more brand agents. The method may continue with providing, based on the identification data, a URL to the service provider to join the two-way communication channel. The method may further include initiating an at least three-way conversation between the customer, the service provider, and the brand agents upon opening of the URL by the service provider.

According to yet another example embodiment of the present disclosure, the operations of the above-mentioned method are stored on a machine-readable medium that includes instructions, which, when implemented by one or more processors, perform the recited operations.

Other example embodiments of the disclosure and aspects will become apparent from the following description taken in conjunction with the following drawings.

### BRIEF DESCRIPTION OF THE DRAWINGS

Embodiments are illustrated by way of example and not limitation in the figures of the accompanying drawings, in which like references indicate similar elements.

FIG. 1 shows an example environment suitable for practicing systems and methods for establishing an at least three-way conversation between customers, service providers, and brand agents within an SDN, according to an example embodiment.

FIG. 2 is a block diagram illustrating a system for establishing an at least three-way conversation between customers, service providers, and brand agents within an SDN, according to an example embodiment.

FIG. 3 is a block diagram illustrating an SDN conversation management flow provided by a system for establishing an at least three-way conversation between customers, service providers, and brand agents within an SDN, according to an example embodiment.

FIG. 4 is a block diagram illustrating components of a system for establishing and managing conversations between customers, service providers, and brand agents within an SDN, according to an example embodiment.

FIG. 5 illustrates a user interface showing a customer interacting with a brand's system in a self-service mode to make a request and enter metadata to be passed to the SDN conversation system, according to an example embodiment.

FIG. 6 shows a user interface of a standard messaging application displayed on a user device of a customer upon initiation by the SDN conversation system of a two-way communication channel, according to an example embodiment.

FIG. 7 illustrates a user interface of a standard messaging application displayed on a user device of a service provider upon the SDN conversation system inviting the service provider to join a conversation with a customer, according to an example embodiment.

FIG. 8 shows a user interface of the SDN on demand portal provided on a user device of a service provider upon opening a link by the service provider, according to an example embodiment.

FIG. 9 shows user interfaces illustrating a three-way conversation between a customer, a service provider, and brand agents, according to an example embodiment.

FIG. 10 is a user interface showing an SDN agent portal used by brand agents to monitor and engage in a three-way conversation, according to an example embodiment.

FIG. 11 illustrates a method for establishing at least a three-way conversation between customers, service providers, and brand agents within an SDN, according to an example embodiment.

FIGS. 12A, 12B, and 12C illustrate a block diagram showing an SDN conversation management flow provided by a system for establishing and then ending an at least three-way conversation between customers, service providers, and brand agents within an SDN, according to an example embodiment.

FIG. 13 is a high-level block diagram illustrating an example computer system, within which a set of instructions for causing the machine to perform any one or more of the methodologies discussed herein can be executed.

### DETAILED DESCRIPTION

The following detailed description of embodiments includes references to the accompanying drawings, which form a part of the detailed description. Approaches described in this section are not prior art to the claims and are not admitted to be prior art by inclusion in this section. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and operational changes can be made without departing from the scope of what is claimed. The following detailed description is, therefore, not to be taken in a limiting sense, and the scope is defined by the appended claims and their equivalents.

The present disclosure relates to systems and methods for establishing at least three-way conversations between customers, service providers, and brand agents within an SDN. The system for establishing an at least three-way conversation between customers, service providers, and brand agents within an SDN is also referred to herein as an SDN conversation system. Organizations orchestrating SDNs, also referred herein to as brands, may adopt the SDN conversation system by using an Application Programming Interface (API) associated with the SDN conversation system. This automated provisioning of the SDN conversation system may help the brand to define, initiate, manage, store, and analyze conversations and conversational workflows between the brand, a service provider (also referred to as a provider), and a customer, or between the brand and the service provider, the brand and the customer, or the service provider and the customer in the SDN via a simple plug-in process or automated provisioning.

A brand may include an independent entity engaged in providing products and services to customers, a business entity engaged in providing products or services, or an organization engaged in activities requiring individuals' interactions. The brand may be represented by an associate of the brand, one or more, brand agents, brand employees, bots, and the like. In an example embodiment, a brand may include a third-party aggregator of service providers providing service on behalf of other brands. A customer may include an individual or business that procures services or products from the brand or an individual or business interacting with the brand. A service provider (or simply provider) may include an independent entity or a business entity engaged in delivering or providing services to customers on behalf of a brand or another business entity partnering with the brand to offer services and products to a customer or an independent business entity.

A network of service providers of the brand can encompass thousands of individual businesses ranging from single person businesses to large organizations. By standardizing conversational customer engagement across the SDN with the system of the present disclosure, brands can significantly improve managing communications between customers and service providers and, hence, improve customer satisfaction.

Key adoption and operational challenges may arise, especially for large SDNs with less frequent events. These challenges include software deployment, event acceptance, readiness to respond, and oversight. Specifically, the software deployment challenge may arise because brands with large networks of providers usually have uneven distribution of SDN events (e.g., requests, assignments, and leads). For some SDNs, only a few providers receive a high enough volume of events to justify adoption of a new software tool including business process changes, account setup, and training.

The event acceptance challenge may occur because when the frequency of events is low, the brand's share of the provider's business activity is low as well, and, as a result, the brand cannot rely on the provider being available to respond to any given event and needs to confirm acceptance. Confirmation may require additional conversation between the brand and the provider on the requirements of the customer before acceptance. If the provider does not accept the event, the event may need to be efficiently transferred to a different provider.

The readiness to respond to a challenge occurs when the provider is willing to accept the event, but is not ready to engage the customer immediately. Depending on the nature of the customer request and the relationship between the brand and the provider, it may be appropriate to allow the provider to engage with the customer when the provider is ready.

The oversight challenge may occur when, with a large SDN, especially when the providers are independent of the brand, there can be significant variability in the quality and capability of the providers, leading the brand to desire closer oversight of the providers, granted permission by the providers. Oversight may range from monitoring responsiveness, reviewing conversations, or directly engaging in conversations with customers and providers as needed.

The system of the present disclosure resolves the adoption and operational challenges by provisioning the SDN conversation system, in an example embodiment, with three components: an SDN provider request, an SDN on demand portal, and an SDN agent portal.

The SDN provider request is an element of the SDN collaborative conversation orchestration component that allows the brand, in one embodiment, to start a three-way conversation between the brand, a customer, and a provider by inviting the provider to join an existing two-way conversation between the brand agents and the customer. The SDN provider request may include an invitation message sent by the brand to the provider and may include an on demand link (also referred herein to as a link), which, in one embodiment, is a URL to a user interface associated with the SDN conversation system. The URL, when selected by the provider, adds the provider to an existing two-way conversation between the brand agents and the customer thereby initiating the three-way conversation between the provider, the customer, and the brand agents.

In another embodiment, the SDN provider request is an element of the SDN collaborative conversation orchestration component that allows the brand to invite a provider to start a three-way conversation between the brand, a customer, and the provider. The SDN provider request may include an invitation message sent by the brand to the provider and may include an on demand link, which, in one embodiment, is a URL to a user interface associated with the SDN conversation system. The URL, when selected by the provider, initiates opening of a conversation between the provider, the customer, and the brand agents thereby initiating the three-way conversation between the provider, the customer, and the brand agents.

The SDN provider request thereby addresses the event acceptance and readiness to respond to operational challenges. The SDN provider request further provides brands with a means to query providers as to whether the providers are willing to accept an event and engage the provider in a conversation concerning customer expectations as they understand them. The SDN provider request allows providers, in one embodiment, to wait until the providers are ready to respond before selecting the on demand link, giving providers control over when the conversation requested by the brand is initiated.

The SDN on demand portal is an element of an SDN conversation portal that allows the provider to conduct a conversation with a customer without any prior adoption of the SDN conversation system. In one embodiment, when the on demand link is selected by the provider, the SDN on demand portal launches in a local web browser of a user device of the provider as a web application or a mobile web application with the conversation already started and no further authentication is required from the provider.

The SDN agent portal is an element of an SDN conversation portal that allows brand agents (which can include employees of the brand, bots, and so forth) to initiate, monitor, and participate in conversations between providers and customers, as allowed by the provider. In one embodiment, when the on demand link is selected by the provider and a conversation is started between the provider and the customer, the conversation also appears in the SDN agent portal and is displayed to the brand agents.

The method for establishing at least a three-way conversation between customers, service providers, and brand agents within an SDN may commence with receiving a request from a customer for a service by the SDN. The method may continue with collecting metadata associated with the customer and providing the collected metadata to the brand. The method may continue with receiving identification data associated with a service provider. The service provider may be selected by the brand based at least on the metadata. The method may further include initiating a two-way communication channel between the customer and one or more brand agents. The method may continue with providing a URL to the service provider to join the two-way communication channel. The method may further include starting the three-way conversation between the customer, the service provider, and the brand agents upon opening the link by the service provider.

In an example embodiment, enabling the conversations between the service provider and the customer may include determining whether the service provider has installed a software agent associated with the system of the present disclosure. If the service provider has not installed the software agent, a message can be sent to the service provider with a request to accept the request of the customer by following a link to a web-based user interface associated with the system of the present disclosure. The web-based user interface may be dedicated to the conversations that can be sent between the particular service provider and the customer.

The method may further include managing the conversations between the customer and the service provider while the request is pending. The management of the conversations may include transferring the conversations to another service provider based on predetermined criteria. The management of the conversations may be performed by the brand agents using a user interface.

In an example embodiment, all data associated with the conversations, the customer, and the service provider may be collected and stored for future use and analysis. The collected data can be analyzed based on predetermined criteria. For example, the collected data can be analyzed for response time of a specific service provider, number of services provided by specific service providers, and so forth.

In an example embodiment, the brand may be enabled to plug in an API associated with the system of the present disclosure into a Customer Relationship Management (CRM) system of the brand to define, initiate, manage, store, and analyze conversations and conversational workflows for providers to deliver services to customers.

According to another embodiment, the brand can plug in the system of the present disclosure into the brand's ticketing system. The brand may upload a list of providers including contact information of the providers and set rules for conversations of providers with the customers. In other embodiments, the system of the present disclosure may help the brand to manage the conversations between a customer, a brand, and a provider, with automatic initiation of conversations between the provider and the customer once the brand receives a request for the service. Neither the provider nor the customer need to download additional applications or log in to avail of the services. The conversations may be performed via messaging, such as text messaging. Moreover, once the brand receives a request from a customer, the system may automatically initiate a conversation with the provider via instant messaging. The brand can set the rules for such conversations. The brand may oversee the conversations or even actively participate in these conversations.

According to another example embodiment, the system of the present disclosure may be used across a network of providers without having such providers to adopt the system. In another embodiment, the system may initiate conversations on demand for providers, in which a provider may receive an instant message from a brand prompting the provider to join a conversation with the customer. If the provider accepts the request for service, the provider is automatically provisioned into the system and can participate in the conversation with the customer, allowing the provider to instantly connect with the customer and start services.

As used herein, a message within the system may include a message from a customer, a provider, or a brand sent via various communication channels such as SMS or MMS text messaging into the SDN. The system may be configured to construct a human-readable message based on the input parameters and synthesize input parameters for a custom message definition based on data, algorithms, or models from multiple sources including the brand, the provider, the customer, historical information, or conversational data.

Thus, the systems and methods of the present disclosure automatically establish and manage conversations between customers, service providers, and brand agents within an SDN. Upon receiving a request for a service from a customer, the system initiates a two-way communication channel between the customer and one or more brand agents. The two-way communication channel may be initiated by establishing an SMS channel for sending messages between a phone number associated with the customer and a phone number associated with the brand.

The system then sends a link to the service provider inviting the service provider to join the conversation with the customer. Upon opening the link by the service provider, the two-way communication channel is used to establish a three-way conversation as the service provider is added to the conversation. The three-way conversation can use the same two-way communication channel established between two phone numbers, specifically, the phone number of the customer and a phone number associated with the brand.

The service provider then is now able to participate in this multiparty conversation using a two-way communication channel between the brand and the customer.

Conventional group text messaging systems for customers built into devices like iPhone® (e.g., iMessage® by Apple®) require a separate phone number for each participant of a conversation and everyone can see every participant's phone number. Moreover, new participants can be added to the conversation at the time the group is created or after, and existing participants cannot be removed by other participants of the conversation.

Additionally, in conventional group text messaging systems for business such as, for example, Podium®, Heymarket®, MessageDesk®, and Textline®, a business has one or more phone numbers shared among employees through a secure account for the cloud system and a business phone number is used for messaging customers. Any user of the conventional group text messaging system must have a user account on the system which, following commonly accepted security standards, may restrict access to employees or internal contractors. The business may control which employees can see what messages and how calls are assigned. These conventional systems are generally integrated into other third-party applications that can be used to start a text message conversation. The conversations are all two-way conversations established between the customer and employees, where the employees can be a group.

In contrast, the system of the present disclosure expands the use of group text messaging for brand beyond just the employees or internal contractors of the brand by enabling multiple external, ad hoc participants to participate in three-way conversations over a two-way communication channel controlled by the brand. Specifically, in addition to what is provided by existing group text messaging applications, the system of the present disclosure also creates a link to the conversation between the customer and the brand agents and allows the link to be shared with third parties (such as service providers) outside the brand to join the conversation at will. Moreover, the system provides the brand with the control over the outside entities that can join the conversation, control over closing the conversation, control over what information can be shared in the conversation, and so forth.

Moreover, according to the disclosed embodiments, a customer does not need to have any specialized applications installed on a user device of the customer. Instead, after the customer requests the service (e.g., by visiting a website of the brand via a web browser), the customer receives and sends all further messages via standard messaging applications already installed on a user device of the customer and used routinely by the customer for messaging (e.g., SMS, SMS/MMS, Facebook® Messenger, WhatsApp®, Apple® iMessage®, Telegram®, and so forth). Similarly, a service provider does not need to have any specialized applications installed on a user device of the service provider. Specifically, upon receiving a message with a link and opening the link, a web page and a user interface associated with the link can be opened with a default web browser running on the user device of the service provider.

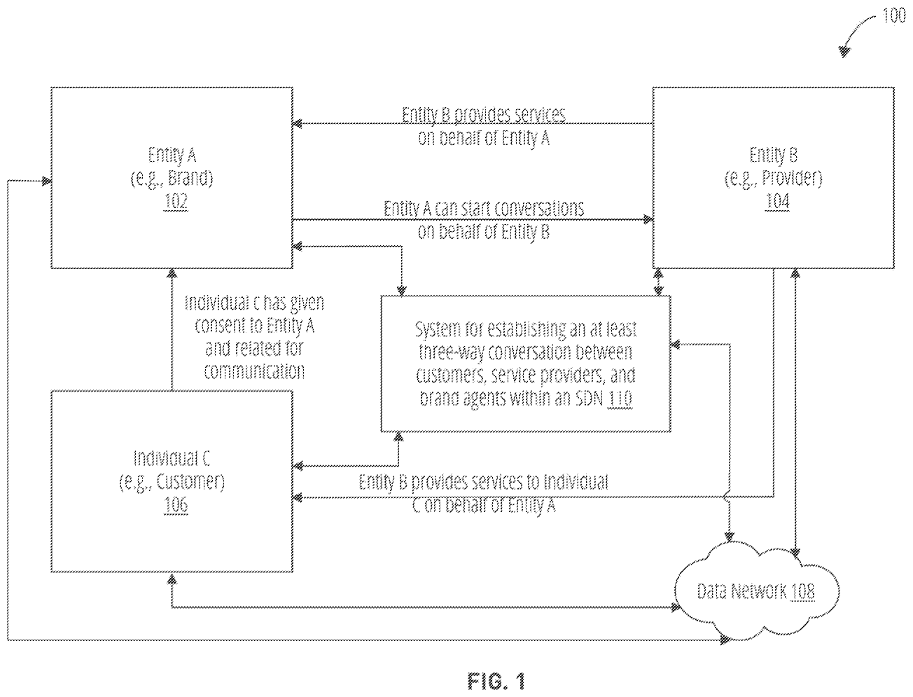

FIG. 1 shows an example environment 100 suitable for practicing systems and methods for establishing an at least three-way conversation between customers, service providers, and brand agents within an SDN as described herein. It should be noted, however, that the environment 100 is just one example and is a simplified embodiment provided for illustrative purposes, and reasonable deviations of this embodiment are possible as will be evident to those skilled in the art.

As shown in FIG. 1, the environment 100 may include an entity A 102, an entity B 104, an individual C 106, a data network 108, and a system for establishing an at least three-way conversation between customers, service providers, and brand agents within an SDN, which is also referred herein to as an SDN conversation system 110 or a system 110. The environment 100 illustrates a contractual relationship that may be established between entities responsible for delivering a service such as a brand, a provider, and a customer allowing conversations to be initiated, conducted, and managed by the SDN conversation system 110 between the brand, the customer, and the provider. FIG. 1 also illustrates a contractual relationship that may be established between a brand and a customer, a brand and a provider, or a provider and a customer. To participate in the methods and systems of the present disclosure, a customer may be asked to provide certain permissions as part of the then-current regulatory program and brand's contractual terms requesting the customer (such as an individual) to opt-in or opt-out from certain type of interactions or messages which may be shared as part of the relationship to be formed in the SDN. Once the customer, the brand, and/or the provider enter into a relationship to participate in the system of the present disclosure, the system may allow the customer, the brand, and the provider to send messages in real time to each other for current updates about the products and services procured from the brand and to be delivered by the provider.

As way of an example, FIG. 1 illustrates a simple case of an SDN consisting of two entities, the entity A 102 and the entity B 104, that together provide a service to the individual C 106. The individual C 106 is a direct customer of the entity A 102 and has requested a service from the entity A 102. As a consequence of its customer relationship with the entity A 102, the individual C 106 gives consent to the entity A 102 to provide communication to the individual C 106. Contractual language may be included in an agreement defining the entity A 102 and the individual C 106 relationship to extend that consent to allow related parties to provide communications to the individual C 106 to deliver the requested service to the individual C 106.

The entity B 104 may be then contracted with the entity A 102 to provide services to the individual C 106 on behalf of the entity A 102. Contractual language may be included to grant the permission of the entity A 102 to start conversations on behalf of the entity B 104 with customers such as the individual C 106, where such conversation may happen only if the entity A 102 has the required consent for such conversations from the individual C 106. As a consequence of its customer relationship between the entity A 102 and the individual C 106, the service provider relationship between the entity A 102, and the entity B 104, and the essential contractual language heretofore described, the entity B 104 may be permitted to provide communication to the individual C 106 to deliver the services to the individual C 106 and the entity A 102 may be permitted to start conversations between the entity B 104 and the individual C 106 to facilitate the delivery of the services by the entity B 104 to the individual C 106 on behalf on the entity A 102.

In an example embodiment, the entity A 102, the entity B 104, and the individual C 106 may communicate with each other and the system 110 via the data network 108. The data network 108 can refer to any wired, wireless, or optical networks including, for example, the Internet, intranet, local area network (LAN), Personal Area Network, Wide Area Network (WAN), Virtual Private Network, cellular phone networks (e.g., Global System for Mobile (GSM) communications network), 3G, 4G, 5G network, Wi-Fi® network, packet switching communications network, circuit switching communications network), Bluetooth® radio, Ethernet network, an IEEE 802.11-based radio frequency network, a Frame Relay network, Internet Protocol (IP) communications network, or any other data communication network utilizing physical layers, link layer capability, or network layer to carry data packets, or any combinations of the above-listed data networks. In some embodiments, the data network 108 may include a corporate network, a data center network, a service provider network, a mobile operator network, or any combinations thereof.

In some embodiments, the system 110 may be implemented as a server(s) or a cloud-based computing resource(s) shared by multiple users. The system 110 can include hardware and software available at a remote location and accessible over a data network 108. The system 110 can be dynamically re-allocated based on demand. The cloud-based computing resource(s) may include one or more server farms/clusters including a collection of computer servers that can be co-located with network switches and/or routers.

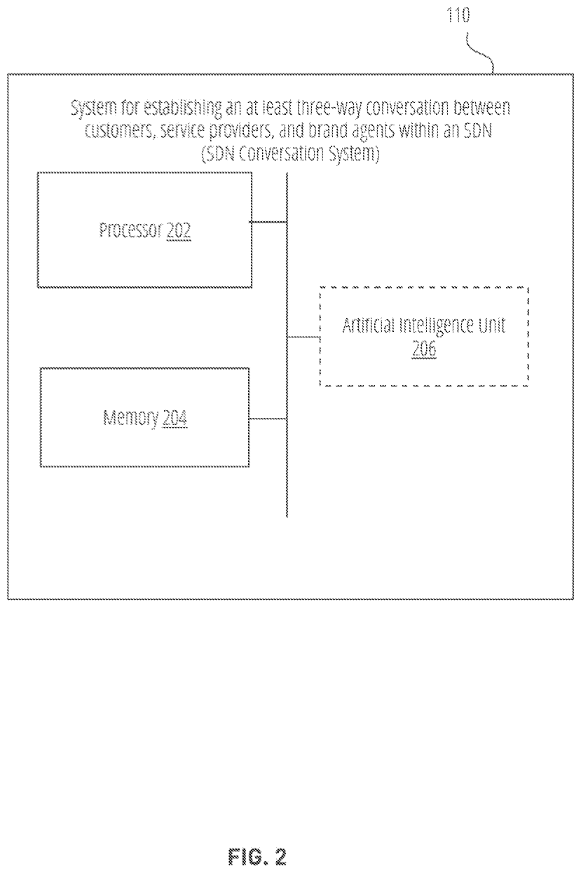

FIG. 2 is a block diagram illustrating a system 110 for establishing an at least three-way conversation between customers, service providers, and brand agents within an SDN, according to an example embodiment. The system 110 may include a processor 202 and a memory 204 configured to store instructions executable the processor 202. The system 110 may further optionally include an Artificial Intelligence (AI) unit 206.

The processor 202 may be configured to receive, from a user device of the customer, the request for the service to be provided by the SDN. In an example embodiment, the request sent by the customer may be provided directly to a brand, brand's systems, or one or more brand agents associated with the brand. In an example embodiment, the processor 202 may receive, from a computing device of a brand, an event indicating that the brand received the request for a service from the customer.

The processor 202 may be further configured to collect metadata associated with the customer. The metadata may include one or more of the following: a name of the customer, a phone number of the customer, a price associated with the service, an identifier associated with the request, a location of the customer, information provided by the customer in the request, and so forth. In an example embodiment, the processor 202 may receive the metadata from the computing device of the brand, where the metadata is associated with at least one of the customer (including the communication endpoint associated with the user device of the customer), the brand, the one or more service providers, the request, the service, and so forth.

In an example embodiment, in response to the request and based on the collected metadata, the processor 202 may initiate a two-way communication channel between the customer and one or more brand agents. The processor 202 may provide, through the two-way communication channel, an initial response to the customer regarding the service. The initial response may prompt the customer to provide a portion of the metadata. In an example embodiment, the initial response may be synthetized using the metadata in combination with the one or more of a message template defined by the brand and algorithms, statistical, or machine learning models predetermined by the brand. The initial response may be sent to the user device of the customer from one or more communication endpoints assigned to and under the control of the brand, thereby establishing a multiparty conversation between one or more brand agents and the customer through the two-way communication channel.

The one or more brand agents may include one of the following: one or more human agents, a bot, and a combination of the one or more humans and bots. The one or more human agents and the bot agent may be affiliated and controlled by the brand that orchestrates the SDN. For example, upon receiving the request from the customer, a bot agent may join the two-way communication channel and automatically send the initial response and any subsequent messages (e.g., asking the customer to provide additional information on the request) to the customer. Therefore, no live person agent may be involved in sending the initial response. In another example embodiment, the live person agent may join the two-way communication channel upon receiving the request from the customer and send the initial response and subsequent messages, if needed, to the customer.

The processor 202 may be further configured to provide the metadata to the brand. The brand receives the metadata and selects a service provider for provisioning the service to the customer. In an example embodiment, the service provider can be selected (automatically by a CRM system of the brand or manually by a brand agent) from a plurality of service providers associated with the SDN. In another example embodiment, the brand may select (automatically by the CRM system of the brand or manually by a brand agent) a predetermined service provider associated with the customer. The selection can be made based on the metadata and using search and selection criteria, algorithms, or statistical or machine learning models. In some example embodiment, more than one service provider can be selected for providing the service to the customer.

Upon selecting the service provider, the brand may send identification data associated with the service provider to the processor 202. The identification data may include, for example, a phone number or any other identifier. The processor 202 may be configured to receive the identification data associated with the service provider. For example, the processor 202 may identify the service provided based on an event that indicates that the request has been assigned to the service provider associated with the SDN.

In an example embodiment, the brand may store a list of service providers in a database and provide the processor 202 with an access to the list. The list may store identification data of a plurality of service providers. The processor 202 may access the list of service providers, identify the service provider based on the identifier received in the identification data from the brand, and retrieve the phone number of the service provider from the database.

Upon initiating the two-way communication channel between the customer and the one or more brand agents, the processor 202 may provide a URL to the service provider to join the two-way communication channel. In particular, the URL may be provided to the service provider by sending a message including the URL to the service provider. When more than one service provider is selected, a unique URL is synthesized for each selected service provider such that the URL, when activated, allows the service provider to join a previously created unique two-way communication channel between the customer and the brand agent.

In an example embodiment, the message may be sent to the service provider via a messaging mechanism based on the identification data of the service provider received from the SDN. The messaging mechanism may include one of the following: an SMS, an email, a stand-alone messenger, a social media messenger, and so forth. The processor 202 may be configured to provide the metadata to the service provider by including the metadata in the message.

In an example embodiment, the URL provided to the service provider may be associated with a web-based user interface. The web-based user interface may enable the service provider to send messages to and receive messages from the customer.

In an example embodiment, the URL may be embedded into a third-party application. The third-party application may include a third-party application previously provided by the brand to the service provider and installed on a user device of the service provider. In another example embodiment, the third-party application may include a third-party application used by the service provider and not associated with the brand.

The processor 202 may be further configured to detect opening of the URL by the service provider. In response to the detection of the opening of the URL by the service provider, the processor 202 may initiate establishing of a three-way conversation between the customer, the service provider, and the one or more brand agents via a two-way communication channel controlled by the brand.

When more than one service provider are selected for a conversation with the same customer, each service provider receives a unique URL. In one embodiment, the processor 202 may further be configured to detect opening of the URL by more than one service provider and, based on an input from the brand or metadata provided by the customer, permit the more than one service provider to join the same conversation. Upon opening of the URL by the service providers, the multi-way conversation is initiated via messaging between the customer, the one or more service providers, and the brand agents via a two-way communication channel controlled by the brand. This embodiment may be useful when several different providers need to collaborate under the direction of a brand to provide service to the customer such as when a plumber, a carpenter, and an electrician need to coordinate under the direction of a general contractor.

In another embodiment, the processor 202 may further be configured to detect opening of the URL by more than one service provider and, based on an input from the brand or metadata provided by the customer, require the more than one service provider to join separate conversations. Upon opening of the URL by the more than one service providers, separate three-way conversations are initiated via messaging between the customer, the brand agents, and each of the more than one service providers via separate two-way communication channels, each controlled by the brand. This embodiment may be useful when a customer is shopping for a provider, such as when the customer visits a marketplace of repair shops and inquires about the cost of a repair from several of repair shops available on the marketplace.

In an example embodiment, the three-way conversation may be initiated by sending an API call. The API call may include the metadata associated with the customer and may identify the service provider.

In an example embodiment, the initial response sent through the two-way communication channel and messages sent through the three-way conversation can be provided to the customer via an SMS. The initial response and the messages sent via the SMS may be communicated between a phone number of the customer and a single phone number provisioned for the brand. Specifically, in the two-way communication channel, the messages can be sent between the phone number of the customer and the phone number associated with the brand. The three-way conversation uses the same SMS channel established between two phone numbers with the service provider being able to join and participate in the conversation without having to establish another channel of communication. Thus, the two-way communication channel can be used to establish a three-way conversation.

In an example embodiment, the one or more brand agents can communicate through the two-way communication channel via an application. The application may include a plugin API integrated into a CRM system of the brand. The application may allow the one or more brand agents to monitor, review, and participate in conversations between the customer and the service provider.

In an example embodiment, the one or more brand agents may be able to control the communications between customers and service providers. For example, the one or more brand agents may be enabled to allow one or more service providers of a plurality of service providers to join the two-way communication channel. The one or more brand agents may be enabled to force the one or more service providers to leave the two-way communication channel.

In conventional group texting applications, every participant can see other participant's phone numbers and messages. In the system of the present disclosure, the one or more brand agents may permit or forbid sharing a phone number of the customer and contact information of the customer with the service provider. Similarly, the one or more brand agents may also permit or forbid sharing a phone number of the service provider and contact information of the service provider with the customer. Therefore, the brand controls how the conversation between the parties is happening because the brand may control which information is shared between the parties.

Additionally, the brand can control the conversation by providing templates to the service providers with predetermined messages as well as questions that the service providers can select and send to the customer. This way, the brand may be sure that the service provider does not provide the unnecessary information to the customer.

The one or more brand agents may also enable the customer to participate in multiple simultaneous conversations with one or more service providers of a plurality service providers via an SMS. Specifically, the SDN may provision an individual phone number for each of the one or more service providers. The one or more brand agents may control each of the multiple simultaneous conversations of the customer with the one or more service providers. For example, if the customer wants to communicate simultaneously with three service providers, the system 110 can initiate three simultaneous communication channels, such as, for example, the customer-the brand agent-the service provider 1, the customer-the brand agent-the service provider 2, and the customer-the brand agent-the service provider 3. However, the system 110 does not provide the phone number to each service provider permanently, but rather assigns the phone number to the particular service provider that is currently assigned to communicate with the customer.

The AI unit 206 may be used for performing some steps of the method of the present disclosure. For example, the AI unit 206 may be used in selecting the service provider for the customer. Specifically, the AI unit 206 may use the metadata (e.g., customer identity, initial service request, service metadata, other demographics from the brand) to recommend service providers using a machine learning model trained on prior selections and quality of service results.

In another example embodiment, the AI unit 206 may be used for selecting or construing a response to a customer from the service provider. Specifically, the AI unit 206 may use the metadata, a knowledge base of the brand, and a machine learning model trained on prior responses to formulate responses to requests and messages of the customer.

In another example embodiment, the AI unit 206 may send alerts to the brand agents. Specifically, the brand agents may be responsible for hundreds or thousands of simultaneous conversations between customers and service providers. The AI unit 206 may monitor all these conversations using a machine learning model trained on historic data gathered from previous conversations and annotated or with evidence of interaction by the brand agents to automatically alert the brand agents when a conversation requires their engagement. Similarly, without training, the conversations can be monitored through sentiment analysis to alert the brand agents when their attention is required.

In another example embodiment, the AI unit 206 may be used to support text translation for service providers with limited proficiency in the native language of the customer and the brand. The AI unit 206 may automatically translate both the incoming and outgoing messages of the service providers.

In an example embodiment, the system 110 for establishing an at least three-way conversation between customers, service providers, and brand agents within an SDN may be implemented on a cloud storage. The system 110 can be delivered as Software-as-a-Service (SaaS) accessible via the Internet. In example embodiments, the system 110 can be hosted at Amazon Web Services® (AWS®) on a microservices platform using a variety of services provided by Amazon®, Twilio®, Auth0®, and the like.

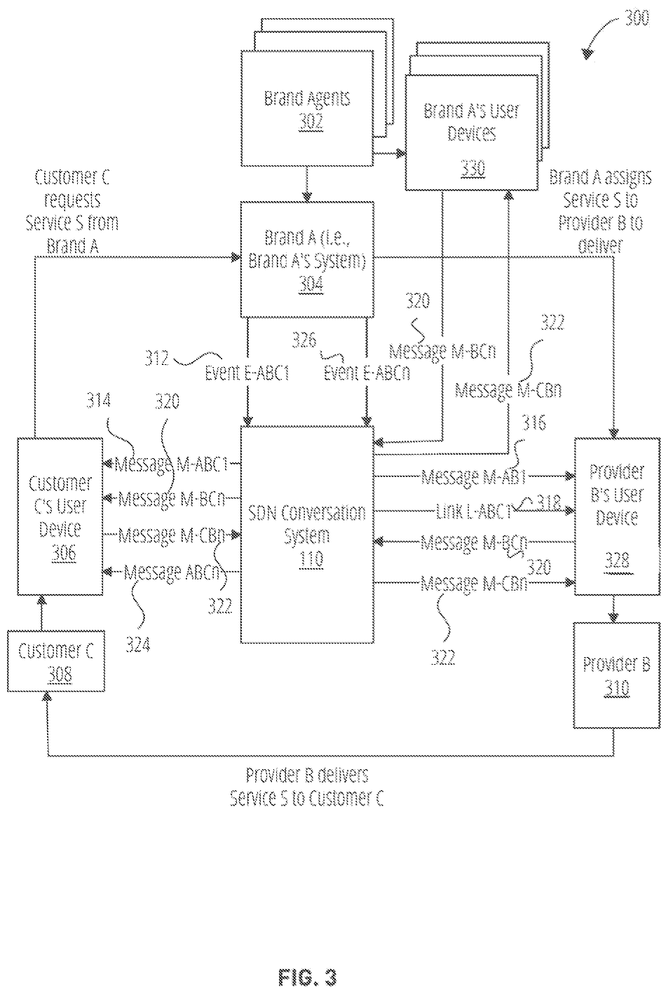

FIG. 3 is a block diagram illustrating an SDN conversation management flow 300 provided by a system 110 for establishing an at least three-way conversation between customers, service providers, and brand agents within an SDN, shown as an SDN conversation system 110. FIG. 3 shows the use of the SDN conversation system 110 in the context of an SDN consisting of a brand A's system of a brand A 304 that provides a service S through a provider B 310 to a customer C 308.

The SDN conversation system 110 in one embodiment is a multi-tenant system where many other brands, in addition to brand A 304 can interact with many other providers in addition to a provider B 310. Specifically, the SDN conversation system 110 may allow the provider B to simultaneously be a provider in the SDN orchestrated by a brand A and a provider in separate SDNs orchestrated by other brands not depicted in FIG. 3. An example may include be a delivery driver who may act as a provider for two different delivery services. Each delivery service may be a distinct brand interacting with the SDN conversation system 110 with their own brand's systems, such as a brand A 304, and brand agents shown as brand agents 302.

FIG. 3 illustrates how the SDN conversation system 110 is used to establish and manage conversations between the provider B 310 and the customer C 308 regarding the service S to be provided by the provider B 310 to the customer C 308 on behalf of the brand A represented by brand agents 302, such as brand A's agents or employees. Furthermore, FIG. 3 also depicts the use by a brand A 304 (i.e., a brand A's system) of the SDN conversation system 110 to initiate and manage conversations between the provider B 310 and the customer C 308 regarding the delivery of the service S to improve the experience of the customer C 308 and to reduce the costs for the brand A and the provider B 310 by avoiding poor service delivery.

As shown in FIG. 3, the customer C 308 requests or purchases the service S from the brand A. A purchase request may occur online or in-person at a retail location or otherwise. By way of example only, the service S may be a result of purchasing a product that requires the service S to install. The service S may be sold separately or as part of a subscription. In an example embodiment, the service S may include a request for a service such that the brand A 304 is introducing one or more potential providers of the service which later conclude with a purchase such as a referral to a real estate agent where the referrer is the brand agent 302 of brand A and the real estate agent is the provider B 310 and the service is the brokering of a future real estate purchase for the customer C 308. In an example embodiment, when the request is made to the brand A 304, the request may be entered into the brand A 304 directly by the customer C 308 or by the brand agent 302 (e.g., an agent or employee) of the brand A 304.

In an example embodiment, the service S may include an automated request from a device owned or assigned to customer C 308 to the brand A 304 system such as when the customer C 308's automobile automatically notifies the automobile manufacturer (as brand A) that customer C 308's automobile may require service such that the brand A 304 then introduces one or more potential providers of the service which later conclude with a service such as a referral to a dealership or an authorized warranty repair shop where the referrer is the brand A 304 and the repair shop is the provider B310.

In an example embodiment, the brand A 304 may, as part of the rules defined by the brand A 304 and the provider B 310, first check to see if the provider B 310 is already provisioned with an account at an SDN conversation portal associated with the SDN conversation system 110. If so, the SDN conversation system 110 may automatically or through the actions of the brand agents 302 assign the service S to the provider B 310 and automatically initiate a conversation between the provider B 310 and the customer C 308. The provider B 310 is expected to deliver the service S to the customer C 308.

In an example embodiment, the selection of the provider B 310 can be performed as follows. The customer 308 in a self-service action may select the provider B 310. In another example embodiment, the brand agent 302 may enter the request into the brand A's system and the brand A's system may select the provider B 310 based on predetermined algorithms. In another example embodiment, the brand agent 302 may select the provider B 310 based on predetermined criteria.

When the brand A 304 assigns the service S to the provider B 310 to deliver, the brand A 304 sends an event E-ABC1 312 to the SDN conversation system 110 to initiate a conversation between the provider B 310 and the customer C 308 regarding the service S.

In a first example embodiment, if the provider B 310 is already provisioned with an account associated with an SDN conversation portal of the SDN conversation system 110, the SDN conversation system 110 may automatically or through the actions of the brand agents 302 assign the service S to the provider B 310 and automatically initiate a conversation between the provider B 310 and the customer C 308 and cause a message M-ABC1 314 to be sent to a user device 306 in use by the customer C 308.

In a second example embodiment, if the provider B 310 does not have the account associated with an SDN conversation portal, the SDN conversation system 110 sends a message M-ABC1 314 from the brand A 304 to a user device 306 of the customer C 308, thereby establishing a two-way conversation between the brand agents 302 and the customer 308. Next, the SDN conversation system 110 sends a message M-AB1 316 from the brand A 304 to a user device 328 of the provider B 310 inviting the provider B 310 to join the conversation between the brand agents 302 of the brand A 304 and the customer C 308. Therefore, in order to be able to participate in the conversation with the customer C 308, the provider B 310 does not have to be a user of the SDN conversation portal associated with the SDN conversation system 110. The message M-AB1 316 may include a link L-ABC1 318. The link L-ABC1 318 may be in the form of a URL. By selecting the link L-ABC1 318, the provider B 310 joins the conversation with the customer C 308 and launches the SDN on demand portal for the provider B 310.

In a third example embodiment, if the provider B 310 does not have the account associated with an SDN conversation portal, the SDN conversation system 110 sends a message M-AB1 316 from the brand A 304 to a user device 328 of the provider B 310 asking the provider B 310 if the provider B 310 wants to have a conversation with the customer C 308. Therefore, in order to be able to participate in the conversation with the customer C 308, the provider B 310 does not have to be a user of the SDN conversation portal associated with the SDN conversation system 110. The message M-AB1 316 may include a link L-ABC1 318. The link L-ABC1 318 may be in the form of a URL. By selecting the link L-ABC1 318, the provider B 310 may indicate that the provider B 310 wants to initiate the conversation with the customer C 308. If the provider B 310 does not select the link L-ABC1 318, no conversation is started. Therefore, the provider B 310 can choose whether the provider B 310 wants to initiate the conversation with the customer C 308 on a customer-by-customer and conversation-by-conversation basis. By selecting the link L-ABC1 318, the provider B 310 initiates the conversation with the customer C 308. The initiation of the conversation is performed by sending a message M-ABC1 314 by the SDN conversation system 110 to the customer C 308 and launching the SDN on demand portal for the provider B 310.

In an example embodiment, the link L-ABC1 318 may be sent to the provider B 310 via a text message, email, social media messaging (e.g., Facebook® Messenger or LinkedIn® Messaging), or other means of sending a message. In some embodiments, the link L-ABC1 318 may be embedded within a button in a user interface of an application shared between the brand A 304 and the provider B 310.

The SDN on demand portal may be configured to simplify and speed up the ability for the provider B 310 to begin a conversation with the customer C 308. Specifically, the SDN on demand portal can be launched with a conversation thread between the provider B 310 and the customer C 308. Furthermore, the SDN on demand portal can be available to the provider B 310 without any prior configuration by launching within a default web browser on a user device on which the provider B 310 received the message M-AB1 316. Additionally, the SDN on demand portal can be accessed by the provider B 310 without further authentication because the SDN on demand portal is limited to presenting only conversations that have been offered specifically to the provider B 310.

Depending on the conditions set by the brand A 304, the provider B 310, and the customer C 308 and the data associated with the event E-ABC1 312, the SDN conversation system 110 may form and send the message M-ABC1 314 via an SMS to the user device 306 of the customer C 308 from a phone number established for the brand A 304 or through another communication device. The message M-ABC1 314 may introduce the provider B 310 to the customer C 308 and include initial information about the service S to be provided by the provider B 310 on behalf of the brand A 304.

Following such conversation route, the system 110 opens a direct channel of communication between the provider B 310, brand A 304, and the customer C 308 and provides the customer C 308 with an opportunity to confirm or update the expectations for the service S. In the absence the SDN conversation system 110, the brand A 304 may have no means to reliably establish a direct communication between the customer C 308 and the provider B 310. Furthermore, in the absence of the SDN conversation system 110, the brand A 304 is dependent on employees of the provider B 310 performing several steps including, among others: (1) noticing that the brand A 304 has assigned the service S to the provider B 310; (2) deciding to reach out to the customer C 308; (3) having a reliable means to communicate with the customer C 308; (4) correctly entering the contact information for the customer C 308 into any communication system the provider B 310 may use to communicate with customers; (5) establishing a connection with the customer C 308, who may not know the provider B 310, through their own communication system; and (6) correctly communicating the information the provider B 310 has been given about the service S to the customer C 308. Furthermore, in the absence of the SDN conversation system 110, the brand A 304 has no visibility of whether the provider B 310 has communicated with the customer C 308, no visibility or control over the timing of the communication, and no visibility or control over the content or form of the initial message from the provider B 310 to the customer C 308. With the use of the system 110, the customer C 308 receives an initial message from the provider B 310 with no action required on the part of the provider B 310 or its employees.

Additionally, with the system 110, the customer C 308 may also send one or more messages collectively represented as M-CBn 322 in response to the message M-ABC1 314. The messages M-CBn 322 are received by the SDN conversation system 110. In an example embodiment, the SDN conversation system 110 may provide the messages M-CBn 322 to one or more user device 330 of brand agents 302. When received, one or more brand agents 302 of brand A who have user accounts in the SDN conversation system 110 and one or more employees of provider B 310 may be notified depending on data provided about the service S, the content and timing of the messages M-CBn 322, data about brand A and the provider B 310, and configuration defined by brand A and the provider B 310. The notified brand agents 302 of brand A and the notified employees of the provider B 310 can view the originating message M-ABC1 314, the response messages M-CBn 322, selected information about the customer C 308, information about the service S, and conversation history that the provider B 310 has had with the customer C 308 through one or more user interfaces associated with the SDN conversation system 110. The user interface may be provided through a web browser, the SDN agent portal, the SDN on demand portal, a native mobile application, or through other means. Depending on data provided about the service S, the content and timing of the messages M-CBn 322, data about the brand A and the provider B 310, and configuration defined by brand A and the provider B 310, one or more employees of the provider B 310 may respond via the user device 328 to the messages M-CBn 322 with one or more messages collectively represented as M-BCn 320. Additionally, depending on data provided about the service S, the content and timing of the messages M-CBn 322, data about brand A and the provider B 310 and configuration defined by brand A and the provider B 310, one or more brand agents 302 may respond via one or more user device 330 to the messages M-CBn 322 with one or more messages M-BCn 320. Therefore, the one or more messages M-BCn 320 may be sent by the provider B 310 or by the brand agents 302. The messages M-BCn 320 may be sent by the one or more user device 330 to the customer C 308 as SMS text messages from the phone number assigned to the brand A 304 or other communication channel preferred by or used by or recommended by or for the customer C 308. The messages M-ABC1 314, M-BCn 320, M-CBn 322, M-ABC1 314, and so forth are collected in a conversation C-ABC1 about the service S.

The SDN conversation system 110 thus allows for the exchange of messages between various entities, such as the provider B 310, the brand agents 302 of the brand A 304, and the customer C 308, thereby improving the quality of the service delivery. With the available technologies and platforms, in the absence of the SDN conversation system 110, the brand A 304 may have sent a message directly to the customer C 308, and the customer C 308 may have responded; however, the responses would go to the brand A 304 and not to the provider B 310. Furthermore, the employees of the provider B 310 may not know of messages sent from the brand A 304 to the customer C 308 with regard to the service S. The provider B 310 may not automatically have information from the brand A 304 about the service S to be able to control which employee responds to the customer C 308. Furthermore, the provider B 310 may have had to accurately transcribe all the information about the customer C 308 and the service S from the brand A 304 to provide context for the conversation.

Based on actions taken by the customer C 308, the provider B 310, or the brand A 304 or depending on the content of the conversation, the data about the service S, or configuration established by the brand A 304 or the provider B 310, additional messages may be interjected into the conversation between the provider B 310 and the customer C 308 and actions may be taken regarding the conversation. One example may be an event, for example, an event E-ABCn 326 from the brand A 304 as a result of the provider B 310 notifying the brand A 304 that the service S has been completed. Depending on the conditions set by the brand A 304, the provider B 310, and the customer C 308 and the data associated with the event E-ABCn 326, the SDN conversation system 110 may form and send a message M-ABCn 324 via SMS and then close the conversation between the provider B 310 and the customer C 308. Using the system 110, the brand A 304 can send a follow-up message inquiring about the quality of the service S and checking with the customer C 308 to see if there are any unresolved issues. With the currently available technologies, in the absence of the system 110, the brand A 304 may have no ability to exercise any control over conversations of the provider B 310 with the customer C 308. The provider B 310 may have to manually close the conversation with the customer C 308 when the service S was completed.

In an example embodiment, communications of the brand A 304 can be established using a plugin API. The plugin API may be configured to automatically construe messages associated with the communications. The API may be integrated with a CRM system of the brand A 304. In an example embodiment, the brand A 304 may use the API to perform monitoring of and engaging in the communications between the customer C 308 and the one or more service providers.

In an example embodiment, the communications can be enabled automatically in response to the customer C 308 and the one or more providers agreeing to mutually satisfactory terms of the communications. The mutually satisfactory terms may include availability rules and interest of the one or more providers in providing the service to the customer. The availability rules may include at least one of a service type and times for the one or more providers to respond to the request.

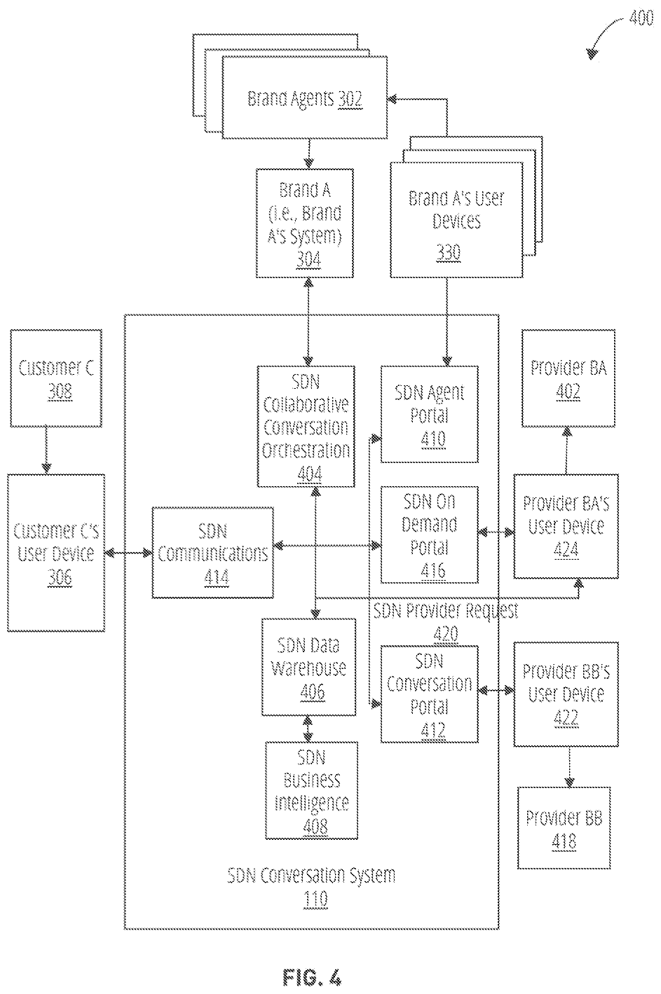

FIG. 4 is a block diagram illustrating components 400 of an SDN conversation system 110 used to establish and manage conversations for SDNs, according to an example embodiment. In an example embodiment, the operations performed by the components of the SDN conversation system 110 may be performed by the processor 202 shown in FIG. 2. In an example embodiment, the SDN conversation system 110 may include the following components: an SDN collaborative conversation orchestration component 404, an SDN conversation portal 412, an SDN on demand portal 416, an SDN communications component 414, an SDN data warehouse component 406, an SDN business intelligence component 408, an SDN provider request 420, and an SDN agent portal 410.

The SDN collaborative conversation orchestration component 404 may provide a programmable means for one or more entities such as a brand A 304 to define, initiate, and manage conversations between other entities and their common customers based on their roles and relationships in the SDN managed by the SDN conversation system 110. Common customers herein are the customers common between the first entity defining the conversation and the second entity delivering the service to the customer on behalf of the first entity.

The SDN conversation portal 412 may provide an application for given entities such as a user device 424 of a provider BA 402 and a user device 422 of a provider BB 418, including the provider's employees, contractors, and other authorized associates, to initiate, conduct, manage, and review conversations with customers and other entities that also use the SDN conversation system 110. The SDN conversation portal 412 may track all conversations for the given entity, which is a part of the conversation, including those initiated by other entities, such as the brand A 304, through the SDN collaborative conversation orchestration component 404. The SDN conversation portal 412 may provide a user interface for the given entity, such as the provider BA 402 or the provider BB 418, to exercise control over the ability for other entities, such as the brand A 304, to initiate and manage conversations between the given entity and customers, such as the customer C 308. The providers such as a provider BB 418 or a provider BA 402 may participate in other SDNs orchestrated by other brands. The SDN conversation portal 412 may track all conversations for the providers across all SDNs in which the providers participate.

The SDN communications component 414 may connect the SDN conversation system 110 to communications infrastructure preferred by customers or providers, such as SMS/MMS, a web chat, WeChat®, Telegram®, Slack®, Skype®, LinkedIn® Messaging, Apple® iMessage® or any other messaging communication channel, to send and receive communications from customers and providers or other entities using means already available to them. The SDN communications component 414 may manage the communication channel, opt-in/opt-out privacy, availability preferences of customers concerning different entities who may or are participating in the SDN conversation system 110 and their roles and relationships in the SDNs with which the customer is engaged.

The SDN data warehouse component 406 may include a shared, authorization-controlled data storage of all information related to the brand, the customer, the provider, services, conversations, and communication data for all SDNs managed by the SDN conversation system 110. The SDN data warehouse component 406 may store the roles and relationships for entities, businesses, and customers in the context of the SDNs in which they participate. The SDN data warehouse component 406 may manage the access to data based on the roles and relationships in the SDN.

The SDN business intelligence component 408 may perform the analysis of data stored in the SDN data warehouse component 406 for customers and authorized brand or provider users of the SDN conversation system 110 based on their roles and relationships in the SDNs managed by the SDN conversation system 110.

An SDN provider request 420 may extend the SDN collaborative conversation orchestration component 404 to allow the brand A 304 to start a conversation between the brand A 304 and the provider BA 402 to ask the provider BA 402 to accept an event from the brand A 304. In one embodiment, the SDN provider request 420 is a message sent via SMS, email, or another communications channel enabled by the SDN communications component 414 to the provider BA 402. In another embodiment, the SDN provider request 420 is a notification in an application shared by the brand A 304 and the provider BA 402, such as a third-party dispatch system.

If defined by the brand A 304-provider BA 402 relationship, the SDN provider request 420 can be configured to always start a conversation or to request the provider's acceptance of the event first or to request the provider's acceptance of the event and the provider's indication that the provider BA 402 is ready to respond.

The SDN provider request 420 may include an on demand link such as a link L-ABC1 318 shown in FIG. 3. In one embodiment, the on demand link is a URL that, when selected by the provider BA 402, initiates a three-way conversation between the provider BA 402, brand agents 302, and the customer C 308. In another embodiment, the on demand link is a URL that, when selected by the provider BA 402, enables the provider BA 402 to join an existing two-way conversation between the brand agents 302 and the customer C308 thereby establishing a three-way conversation between the provider BA 402, the brand agents 302, and the customer C 308. In one embodiment, the on demand link is included in the message sent as the SDN provider request 420. In another embodiment, the SDN provider request 420 may have a link that becomes apparent or clickable in a software agent running on a user device of the provider BA 402.

The SDN provider request 420 may not require any authentication by virtue of the request being sent to a known contact point for the provider BA 402. In another embodiment, the SDN provider request 420 requires authentication from the provider BA 402 after receiving the message before allowing the provider BA 402 to accept the request, join the conversation between brand agents 302 and the customer C 308, or cause the on demand link to start a conversation with the customer C 308.

The SDN provider request 420 may note that the provider BA 402 is an already configured user of the SDN conversation portal 412 and, based on rules defined by the provider BA 402 and/or the brand A 304, start the conversation as described with reference to FIG. 3.

The SDN on demand portal 416 is a component of the SDN conversation portal 412 that allows the provider BA 402 to conduct a conversation with the customer C 308 without any prior adoption of the SDN conversation system of the brand A 304. The SDN on demand portal 416 is launched when the on demand link is selected. The SDN on demand portal 416 does not require any application to be downloaded or installed and is presented as a web application running in a default web browser on a user device where the on demand link was selected. The SDN on demand portal 416 may not require authentication on the part of the provider BA 402 because the provider BA 402 has already been authenticated by virtue of receiving the SDN provider request 420 and, potentially, authorizing the acceptance of the SDN provider request 420. The SDN on demand portal 416 may only display one conversation requested by the brand A 304 for the provider BA 402 with the customer C 308. In another embodiment, the SDN on demand portal 416 may provide access to all the conversations that the provider BA 402 is conducting at the request of the brand A 304 and allow the provider BA 402 to switch between the conversations and customers. In another embodiment, the SDN on demand portal 416 may provide access to all the conversations that the provider BA 402 is conducting at the request of all brands in all SDNs in which the provider BA 402 participates and allow the provider BA 402 to switch between the conversations and customers.

The SDN on demand portal 416 may show the messages from the provider BA 402 and from the customer C 308 in a conversation thread. In another embodiment, the SDN on demand portal 416 may show prior messages between the provider BA 402 and the customer C 308 to provider further context. The SDN on demand portal 416 allows the provider BA 402 to enter a new message including attachments such as documents, images, videos, and other potentially useful items to share either directly or as URL links to the location of a source document. Moreover, the SDN on demand portal 416 allows the provider BA 402 to view similar attachments and embedded objects such as images from the customer C 308.

The SDN on demand portal 416 may provide parameterized template messages defined by the brand A 304. The provider BA 402 may use the parameterized template messages to respond in conversations. The SDN on demand portal 416 may provide automatic responses from the provider BA 402 to messages of the customer C 308. Such automatic responses may include messages, actions, forms, and other responses that can be communicated over messaging as defined and configured by the brand A 304. In one embodiment, the automatic responses from the provider BA 402 to messages of the customer C 308 may be selected based on keywords found in the messages of the customer C 308 as defined and configured by the brand A 304. In another embodiment, the automatic responses from the provider BA 402 to messages of the customer C 308 may be based on one or more of algorithms, statistical analysis, and machine learning as defined and configured by the brand A 304. In another embodiment, the automatic responses from the provider BA 402 to messages of the customer C 308 may be part of a natural language chat bot functionality as defined and configured by the brand A 304.

The SDN agent portal 410 is a component of the SDN conversation portal 412 that allows employees of the brand A 304 to initiate, monitor, and participate, using user device 330, in conversations between providers and customers as allowed by the providers. The SDN agent portal 410 may allow brand agents 302 (agents or employees of the brand A 304) to manually initiate conversations with customers on behalf of providers. The SDN agent portal 410 may allow the brand agents 302 to manually initiate conversations with providers.

The SDN agent portal 410 may automatically show all conversations started by providers using the SDN on demand portal 416. The SDN agent portal 410 may filter conversations shown to particular brand agents based on parameters set by the brand A 304 or the provider BA 402 or the customer C 308. The SDN agent portal 410 may include flags or tags that indicate how long the customer C 308 is waiting for a response from the provider BA 402 as an indication that the brand agents 302 should intervene and interact with the customer C 308.

The SDN agent portal 410 may include access to the SDN business intelligence component's 408 analysis of the responsiveness, or appropriateness of responses by the provider BA 402 to the customer C 308 or the sentiment or intent of the customer C 308 or attempts by providers to disintermediate the brand A 304. The SDN agent portal 410 may allow employees of the brand A 304 to request the ability to monitor and/or participate in conversations by providers in the SDN of the brand A 304 using the SDN conversation portal 412. The SDN agent portal 140 may provide a user interface to control the behavior and rules of the SDN collaborative conversation orchestration component 404.

When a customer wishes to request a service to be provided by a brand, the customer may make a call to a brand agent of a brand, such as a brand A 304 shown in FIGS. 3 and 4. In response to receiving the call with the request for the service from the customer, the brand agent may send a message to the customer.

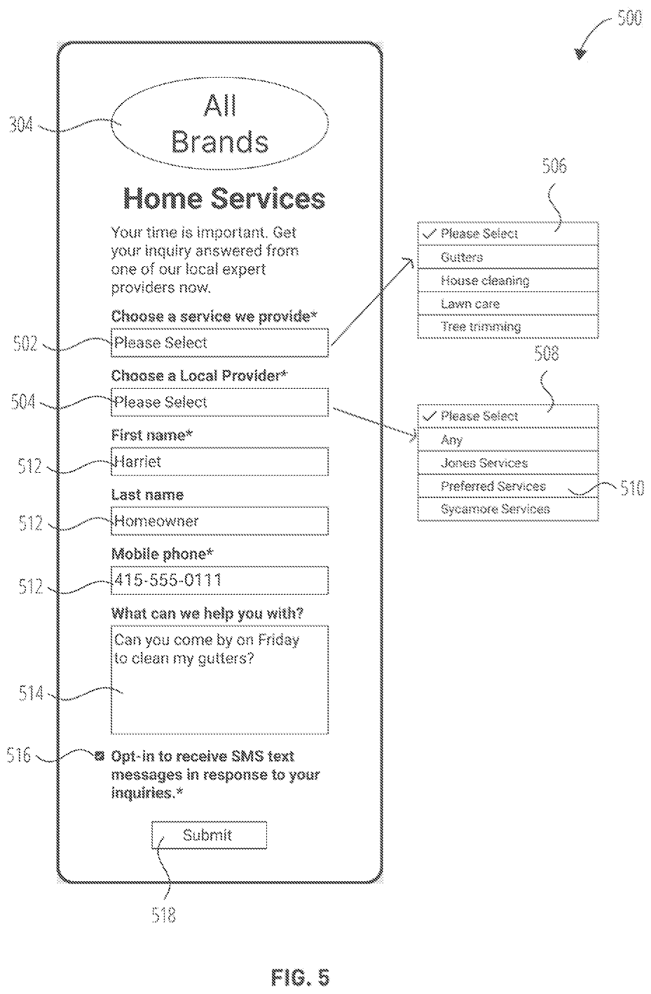

FIG. 5 shows a user interface 500 illustrating an example embodiment of a customer interacting with a brand's system in self-service to make a request and enter metadata to be passed to the SDN conversation system. The customer may visit a website associated with the user interface 500 of a brand 304 (e.g., a marketplace). The system 110 may be connected to the website of the brand via an API. The customer may select a service 502 from a drop-down menu 506 of services. Furthermore, a drop-down menu 508 may be provided to the customer on the user interface 500 to enable the customer to select any of service providers, select a particular service provider (shown as preferred services 510), or select all service providers simultaneously. Therefore, the system 110 enables the customer to start conversations with as many service providers as the customer wants, simultaneously.

The customer may provide metadata 512 related to the service or the customer. The metadata 512 may include a name of the customer, a phone number of the customer, a location of the customer, and so forth. The customer may further provide a request 514, such as, “Can you come by on Friday to clean my gutters?” The system 110 receives the request 514 and sends the request 514 to several service providers (e.g., home service providers). All service providers may respond to the request 514 simultaneously. The system 110 receives the responses and phone numbers of the service providers and uses the phone numbers to establish multiple three-way conversations between the customer and each of the service provider. A brand agent may also have access to the multiple three-way conversations in order to review or participate in each of the multiple three-way conversations.

The customer may further select a check box 516 if the customer agrees to receive text messages (e.g., via SMS) in response to the request 514 made by the customer via the user interface 500. Upon filling in all the fields, the customer may click a submit icon 518. Upon clicking the submit icon 518, the brand's system may send an event (shown as an event E-ABC1 312 in FIG. 3) to the SDN conversation system 110 to start a three-way conversation with the customer, the service provider, and one or more brand agents.

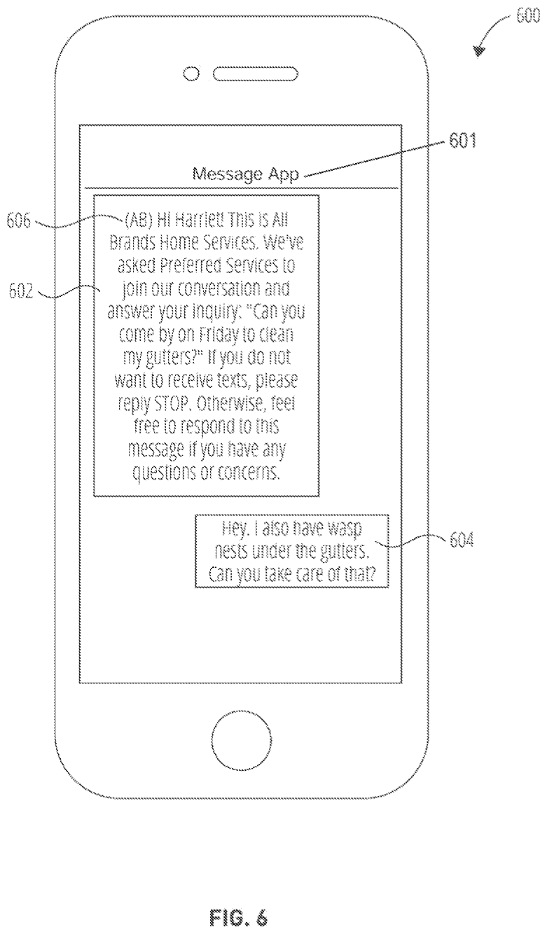

FIG. 6 shows a user interface 600 displayed on a user device of the customer upon opening a two-way conversation channel, according to an example embodiment. To open the two-way conversation channel between the brand agents and the customer, the system 110 sends an initial message in form of a text message 602 to the customer via SMS. The text message 602 is accessed in a standard messaging application 601 provided with a user device of the customer.

The text message 602 is composed to note that the request for the service has been received by the system 110 and that the service provider selected by the customer has been invited to join the conversation in the two-way communication channel with the customer. This way, the brand has set the expectation for the customer that the service provider will participate in the conversation. The initial text message 602 is based on a template that pulls in metadata, such as a first name “Harriet” of the customer, a business name “Preferred Services” of the provider, and the initial inquiry “Can you come by on Friday to clean my gutters?”

The system 110 may be further configured to label messages sent between the customer, the brand agents, and the service provider to indicate which party sends a message. The labeling may include adding a label (i.e., an identifier) associated with a party to each message sent by the party. Specifically, the text message 602 may be labeled with a label 606 to show that the text message 602 has been received from the brand agent and not from any other party of the multiparty conversation. This labeling is important for certain two-way communication channels like SMS that, unlike MMS, do not support indicators of a source of the message.

The customer may respond by sending a message 604 with additional information (i.e., the additional metadata) related to the service. The message 604 may be sent by the user device of the customer as an SMS. The additional information may help the service provider to determine whether the service provider is willing to accept the request.

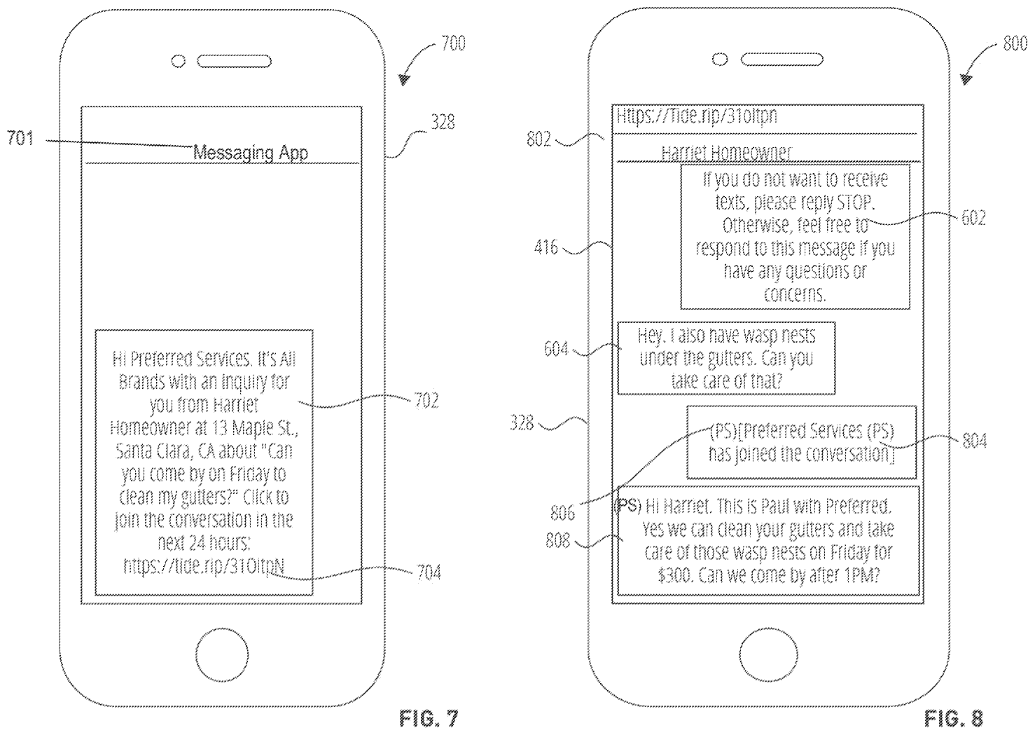

FIG. 7 illustrates a user interface 700 displayed to the service provider upon inviting the service provider to join the conversation with the customer, according to an example embodiment. The system 110 may send an SDN provider request as a message 702 from the brand agent to the service provider. The user interface 700 may display the message 702 communicated by the system 110 to the service provider. The message 702 may be received by the service provider as a text message from a phone number under the control of the brand and accessed by the service provider through a standard messaging application 701 provided with a user device 328 of the service provider. The message 702 may include a link 704, referenced as a link L-ABC1 318 in FIG. 3, inviting the provider to join the two-way communication channel between the customer and the brand agents thereby establishing a three-way conversation between the customer, the provider, and the brand agents. The message 702 may further include metadata related to the service and the customer, such as a business name of the service provider, a name and an address of the customer, and the request.

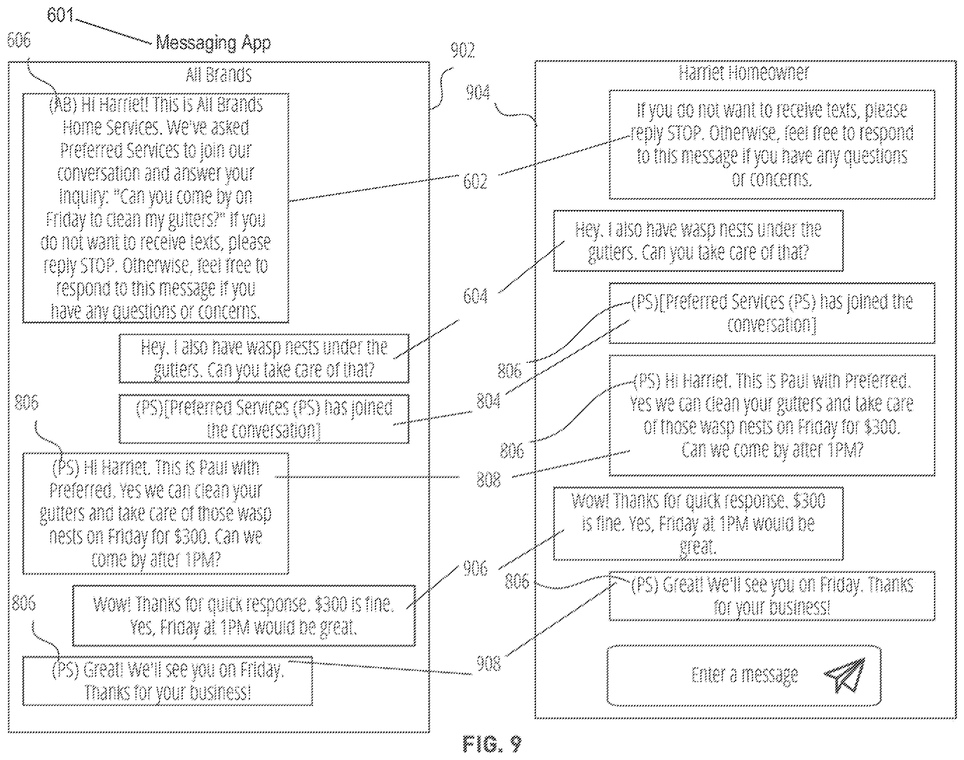

Upon following the link 704, an SDN on demand portal 416 represented by the user interface 800 shown in FIG. 8 may be provided to the service provider. FIG. 8 illustrates the user interface 800 provided on a user device of the service provider upon opening the link in the SDN provider request that was sent in the message 702, according to an example embodiment. The user interface 800 shows the SDN on demand portal 416 opened in the standard browser running on the user device 328 of the service provider. The conversation is now a three-way conversation via a two-way communications channel.

The SDN on demand portal 416 includes metadata 802 concerning the customer and the message 602 sent to the customer from the brand. The SDN on demand portal 416 further includes the message 604 sent from the customer to the brand. In another embodiment, the brand may configure the conversation to not show messages prior to the provider joining the conversation to keep those messages private. The SDN on demand portal 416 automatically announces when the service provider joins the conversation by sending a message 804. A label 806 is added to the message 804 to indicate that the message 804 is the message associated with the service provider. The service provider can respond directly to the customer by sending a message 808 to answer the initial request and the additional questions posed by the customer.

FIG. 9 shows user interfaces 902 and 904 displaying a three-way conversation between a customer, a service provider, and a brand through a two-way communication channel, according to an example embodiment. The user interface 902 is shown on a user device of the customer in the standard messaging application 601. The user interface 904 is shown on the user device of the service provider using the SDN on demand portal in a standard web browser. Both user interfaces 902 and 904 show the initial text message 602 sent to the customer by the system 110 to open the two-way conversation between the brand and the customer and confirm receipt of the request from the customer. The user interfaces 902 and 904 also show the message 604 sent by the customer to the brand with additional information about the request for the service.

Both user interfaces 902 and 904 show the message 804 automatically sent to the customer to announce that the service provider has joined the conversation and that the conversation now has three parties. The user interfaces 902 and 904 also show the message 808 sent by the service provider to the customer to confirm receipt of the original request (e.g., related to gutters) and the follow-up request (e.g., related to wasp nests) and proposing time and price to the customer.

The user interfaces 902 and 904 further display a message 906 sent by the customer to the service provider to confirm the time and the price. The user interfaces 902 and 904 further display a message 908 with a final confirmation sent by the service provider to the customer.

The label 606 may be added to all messages received from the brand agents. The label 806 may be added to all messages received from the service provider. The labelling of messages, i.e., adding the labels 606 and 808 to the messages, may be performed automatically by the system 110 to indicate which party sends a message. The identifiers may be generated based on a business name of the brand (e.g., AB for “All Brands”) and the service provider (e.g., PS for “Preferred Services”) and may include other identifying information about the individual brand agent or an employee of the service provider that responded.

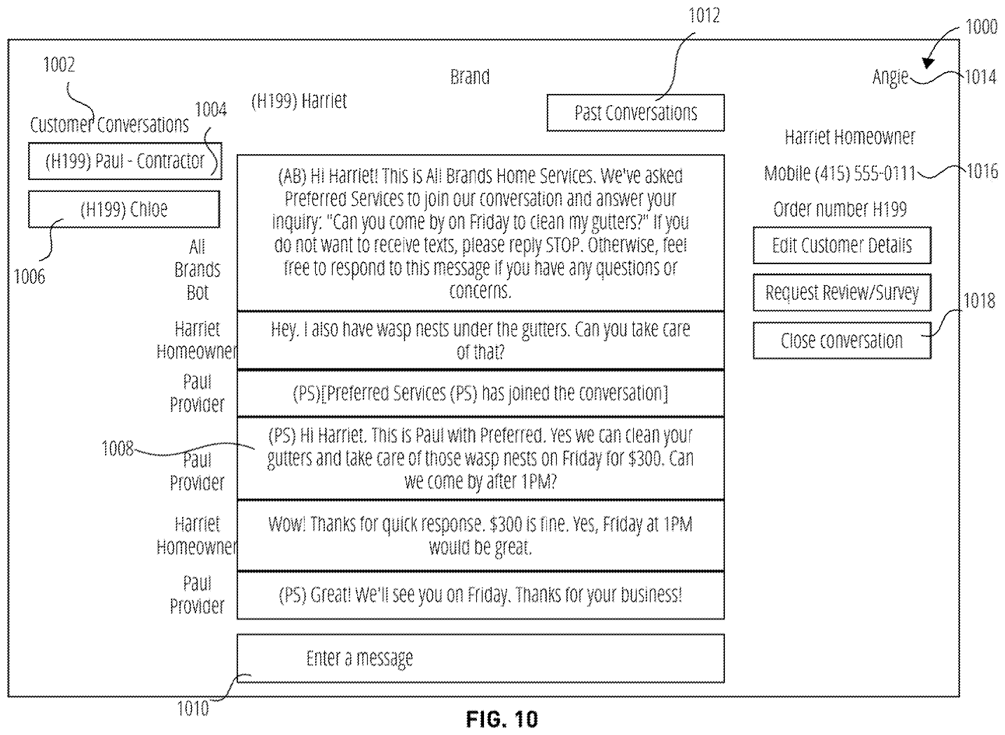

FIG. 10 is a user interface 1000 showing an SDN agent portal used by brand agents to monitor and engage in the three-way conversation if needed, according to an example embodiment. The user interface 1000 shows a list 1002 of active conversations with other customers and service providers. The list 1002 may include, for example, a two-way conversation 1004 between the brand agents and the service provider and a three-way conversation 1006 between the customer, the service provider, and the brand agents.

Upon selecting the three-way conversation 1006, the user interface 1000 may display a conversation thread 1008 of the three-way conversation 1006. The conversation thread 1008 may include all messages sent between the customer, the service provider, and the brand agents. The conversation thread 1008 may allow the brand agent to monitor or engage in the three-way conversation 1006 by entering messages into a field 1010.

The user interface 1000 may further have a button 1012 to show past conversations between the brand agent, the customer and any of service providers. The right portion of the user interface 1000 may show a name 1014 of the brand agent currently signed into the system. The user interface 1000 may further show metadata 1016 concerning the customer and the service to be provided (e.g., the order number). The user interface 1000 may further have a close conversation icon 1018 enabling the brand agent to close the conversation 1006 and send a final message to the customer.

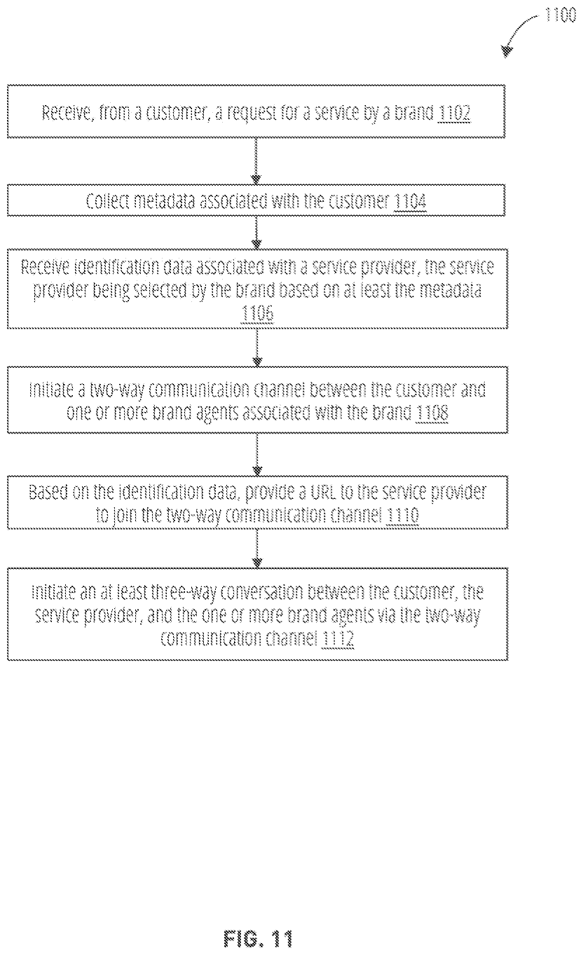

FIG. 11 is a flow chart of a method 1100 for establishing an at least three-way conversation between customers, service providers, and brand agents within an SDN, according to an example embodiment. In some embodiments, the operations may be combined, performed in parallel, or performed in a different order. The method 1100 may also include additional or fewer operations than those illustrated. The method 1100 may be performed by processing logic that may comprise hardware (e.g., a decision making logic, a dedicated logic, a programmable logic, and a microcode), software (such as software run on a general-purpose computer system or a dedicated machine), or a combination of both. In an example embodiment, the method 1100 may be performed by a SaaS deployed in a cloud environment and delivered over the Internet.

The method 1100 may commence in block 1102 with receiving, from a customer, a request for a service by the brand. In block 1104, the method 1100 may continue with collecting metadata associated with the customer. The metadata can include one or more of the following: a name of the customer, a phone number of the customer, a price associated with the service, an identifier associated with the request, a location of the customer, information provided by the customer, and so forth. The metadata may be provided to the brand.

The method 1100 may optionally include providing an initial response to the customer regarding the service. The initial response may be sent in response to receiving the request from the customer. The initial response may prompt the customer to provide further metadata.

In block 1106, the method 1100 may include receiving identification data associated with a service provider from the brand. The service provider may be selected by the brand based on at least the metadata. In an example embodiment, the service provider may be selected from a plurality of service providers associated with the SDN. In another example embodiment, a predetermined service provider associated with the customer may be selected.

In block 1108, the method 1100 may continue with initiating a two-way communication channel between the customer and one or more brand agents. In an example embodiment, the one or more brand agents may include one or more human agents, a bot agent, or a combination of the one or more human and bot agents.

The method 1100 may continue in block 1110 with providing, based on the identification data, a URL to the service provider to join the two-way communication channel. In an example embodiment, the URL may be associated with a web-based user interface. The web-based user interface may enable the service provider to send messages to and receive messages from the customer and the one or more brand agents.

In an example embodiment, the URL may be provided by sending a message including the URL to the service provider. The message may be sent to the service provider via an SMS, an email, a messaging application, a social media, and any other messaging mechanism. In an example embodiment, the message may further include the metadata associated with the customer and the request.

The method 1100 may continue with detecting opening of the URL by the service provider. In an example embodiment, the URL may be embedded into a third-party application. The third-party application may be provided by the SDN to the service provider.

Upon opening the URL, the method 1100 may continue with initiating an at least three-way conversation between the customer, the service provider, and the one or more brand agents via the two-way communication channel between customer and the brand in block 1112.

In an example embodiment, the two-way communication channel may be initiated by sending an API call. The API call may include the metadata associated with the customer and identifying the service provider.

In an example embodiment, the initial response sent through the two-way communication channel may be provided to the customer via an SMS. In an example embodiment, the initial response and the messages sent via the SMS may be communicated between a phone number of the customer and a phone number provisioned for the brand.

In an example embodiment, the one or more brand agents may be able to communicate through the two-way communication channel via an application. The application may enable the one or more brand agents to monitor, review, and participate in conversations between the customer and the service provider.

The one or more brand agents may also control the conversation by allowing one or more service providers of a plurality of service providers to join the two-way communication channel and by forcing the one or more service providers to leave the two-way communication channel. Moreover, the one or more brand agents may permit or forbid sharing of a phone number of the customer and contact information of the customer with the service provider, as well as sharing of a phone number of the service provider and contact information of the service provider with the customer.

The one or more brand agents may also control conversations by enabling the customer to participate in multiple simultaneous conversations with one or more service providers of a plurality service provider via the SMS. An individual phone number may be provisioned for each of the one or more service providers. The one or more brand agents may control each of the multiple simultaneous conversations.

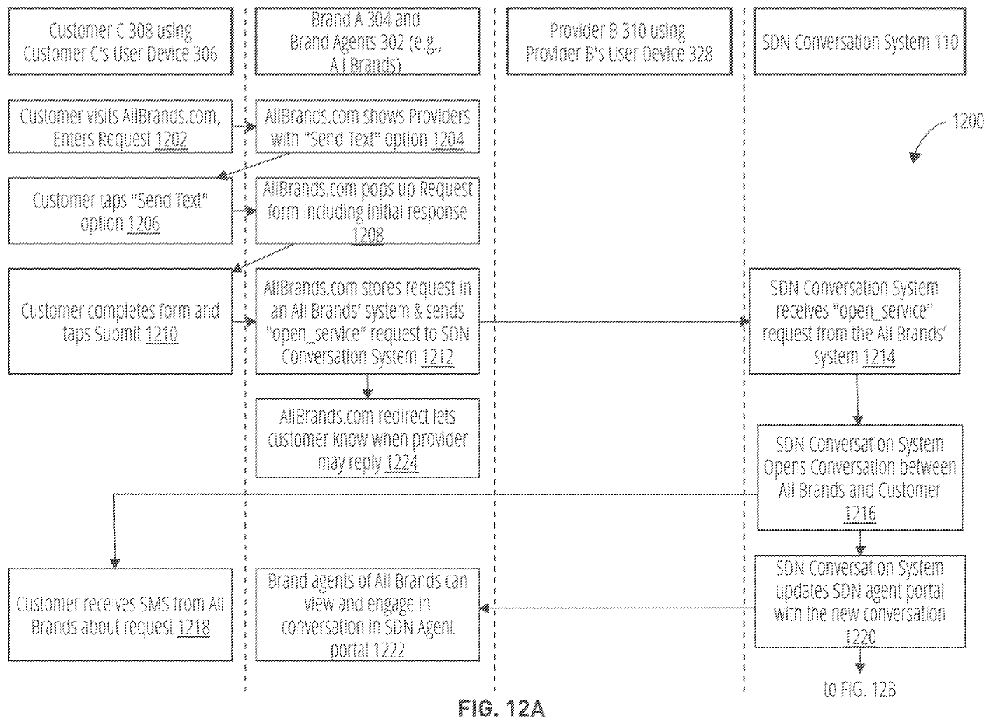

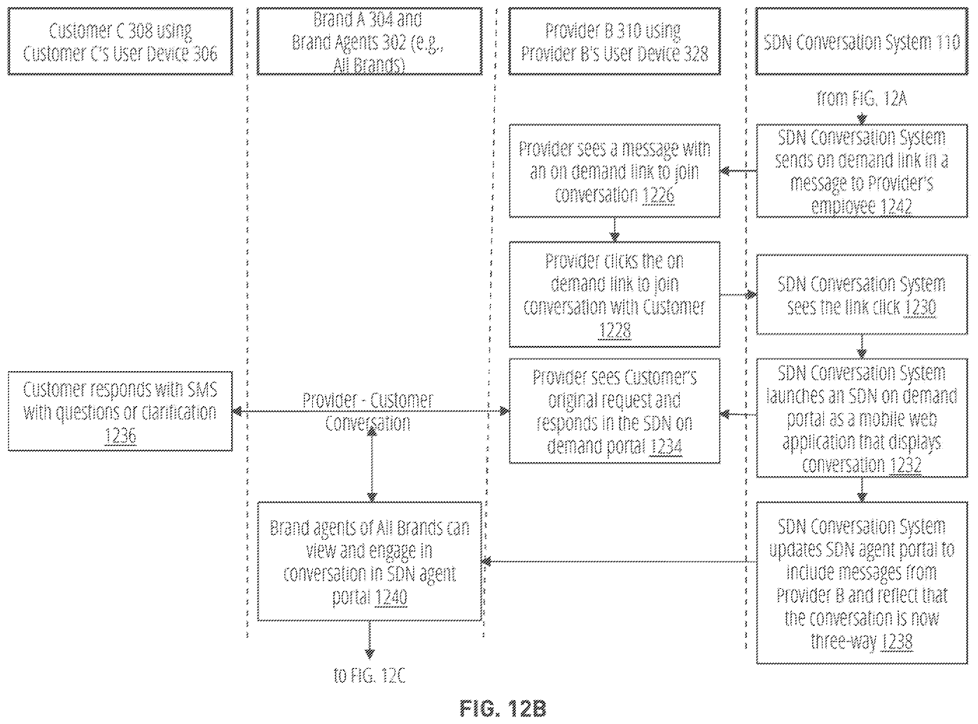

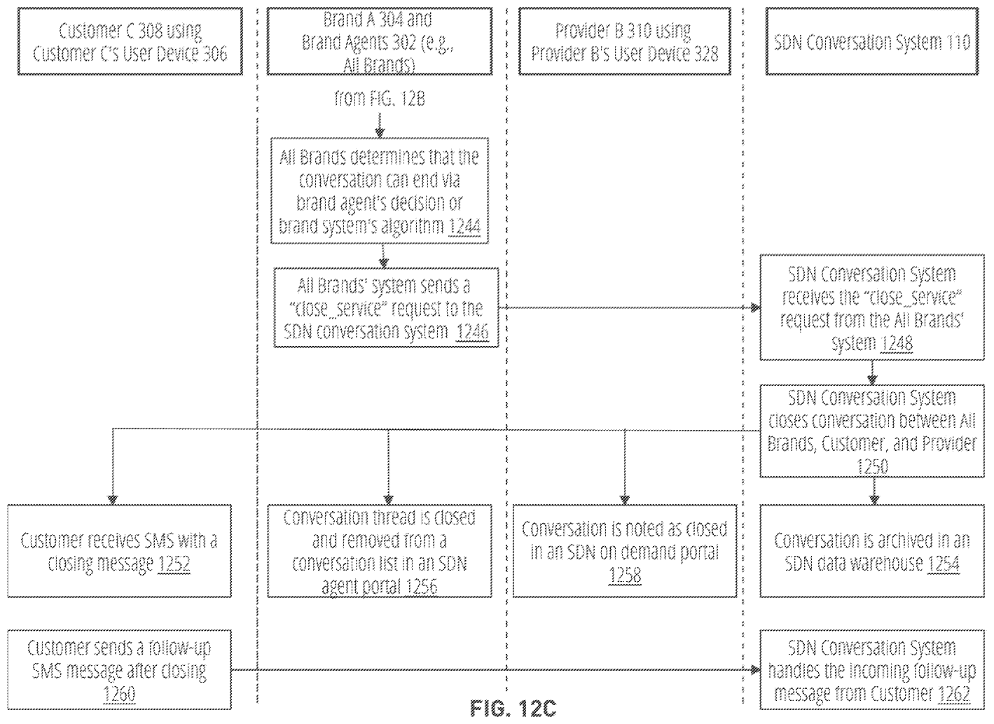

FIGS. 12A, 12B, and 12C show a block diagram illustrating an SDN conversation management flow 1200 provided by a system 110 for establishing an at least three-way conversation between customers, service providers, and brand agents within an SDN, according to an example embodiment. FIGS. 12A, 12B, and 12C show an interaction between a customer C 308 (which uses a customer C's user device 306), a brand A 304 (i.e., a brand A's system) and brand agents 302 associated with the brand A 304, a provider B 310 (which uses a provider B's user device 328), and an SDN conversation system 110. An example brand A 304 includes the All Brands company, which has the All Brands system (i.e., the brand A's system) accessed by customers through the ‘AllBrands.com’ website.

As shown in FIG. 12A, the SDN conversation management flow 1200 starts in block 1202, in which the customer C 308 visits the ‘AllBrands.com’ website of the brand A 304 and enters a request for service to be provided by the brand A 304. In block 1204, in response to the request, the ‘AllBrands.com’ website shows a list of providers and provides a “send text” option. In block 1206, the customer C 308 selects one of the providers (such as the provider B 310) and selects the “send text” option on the ‘AllBrands.com’ website. In block 1208, the ‘AllBrands.com’ website pops up a request form that includes an initial response with additional questions to be answered by the customer C 308. In block 1210, the customer C 308 completes the form and clicks the “submit” button.

In block 1212, the ‘AllBrands.com’ website stores the request into the All Brands system and sends, via an API, an “open_service” request to the SDN conversation system 110. As shown in block 1224, a redirect service of the AllBrands.com website may let the customer C 308 know when the provider B 310 can reply to the request.

In block 1214, the SDN conversation system 110 receives the “open_service” request from the All Brands system. In block 1216, the SDN conversation system 110 opens a two-way communication channel for a conversation between the All Brands (i.e., the brand A 304) and the customer C 308.

The SDN conversation management flow 1200 then proceeds to block 1218, where the customer C 308 receives an SMS message from a communication endpoint established within the SDN conversation system 110 on behalf of All Brands and sent by the SDN conversation system 110 concerning the request. In block 1220, the SDN conversation system 110 updates an SDN agent portal accessible by the brand agents 302 of All Brands with the new conversation where, in block 1222, the brand agents 302 of All Brands may review and engage in the conversation via the SDN agent portal.

As shown in FIG. 12B, the SDN conversation management flow 1200 proceeds to block 1242 with sending an SDN provider request including an on demand link in the form of an SMS message, email, or other communication means including embedding the on demand link into an application used by the provider B 310, to the provider B 310 or an employee of the provider B 310. In block 1226, the provider B 310 can view the SDN provider request that includes an on demand link to join the conversation. In block 1228, the provider B 310 can click the on demand link to join the conversation with the customer C 308. The SDN conversation system 110 detects the click, as shown in block 1230. In block 1232, the SDN conversation system 110 launches the SDN on demand portal as a mobile web application configured to display the conversation on the provider's B user device 328 to the provider B 310. In block 1234, the provider B 310 sees the original request of the customer C 308 in the SDN on demand portal as the mobile web application and responds to the customer C 308.

In block 1236, the customer C 308 responds, via SMS messages with questions or clarifications, to the provider B 310. In block 1238, the SDN conversation system 110 updates the SDN agent portal to reflect that the conversation is now a three-way conversation. As shown in block 1240, the All Brands' brand agents (i.e., the brand agents 302) can view and engage in the conversation between the customer C 308 and the provider B 310 by using the SDN agent portal.

As shown in FIG. 12C, the SDN conversation management flow 1200 can proceed to block 1244 where the brand (e.g., All Brands), as the orchestrator of the SDN, can end the conversation. The conversation can be ended based on a decision by one of the brand agents 302 or by the brand's system based on an algorithm. The brand's system algorithm may be based on an indication from the provider that the service has been completed through means external to the SDN conversation system 110 or through other events.

In another embodiment (not shown in FIG. 12C), the decision to close the conversation may be based on an algorithm of the SDN conversation system 110 configured by the brand A 304. For example, the SDN conversation system 110 may close the conversation if the customer C 308 sends a message with an opt-out keyword such as ‘STOP.’ In another embodiment, the SDN conversation system 110 may be configured by the brand to automatically close the conversation based upon other content in the conversations messages received from one or more of the customer, provider, or brand agents, or based upon the time elapsed since the last message was received from the customer C 308 or other rule, model, statistics, or machine learning inference.

In another embodiment (not shown in FIG. 12C), the decision can be made to force the provider B 310 to exit the three-way conversation causing the conversation to become a two-way conversation between the customer C 308 and the brand agents 302 only. In this embodiment, the purpose can be to switch to another provider or to engage the customer C 308 privately or for any other reason the brand A 304 may deem appropriate.

In block 1246, the All Brands system sends, via an API, a “close_service” request to the SDN conversation system 110. In block 1248, the SDN conversation system 110 receives the “close_service” request from the All Brands system. In block 1250, the SDN conversation system 110 closes the conversation between All Brands (i.e., the brand A 304), the provider B 310, and the customer C 308.

The SDN conversation management flow 1200 then proceeds to block 1252, where, in one example embodiment, based on the configuration provided by the brand of the SDN conversation system 110, an SMS message can be sent from the communication endpoint established within the SDN conversation system 110 on behalf of All Brands to the customer C 308. In one embodiment, the objective of this message may be notifying the customer C 308 that the conversation is closed, thanking the customer C 308, or requesting feedback on the service experience. In another embodiment, the conversation can be closed with no message sent to the customer C 308.

The SDN conversation management flow 1200 then proceeds to block 1258, where the SDN on demand portal may inform the provider B 310 that the three-way conversation is closed and the dialog with the customer C 308 through the SDN on demand portal is no longer available. Further, in one embodiment, based on configuration from the brand of the SDN conversation system 110, a message can be sent from the SDN conversation system 110 on behalf of All Brands to the provider B 310 via an existing two-way communication channel between the brand and the provider or via a newly established two-way communication channel. In one embodiment, the objective of this message can be notifying the provider B 310 that the conversation is closed, thanking the provider B 310, or requesting feedback on the service experience. In another embodiment, the conversation can be closed with no message sent to the provider B 310.

The SDN conversation management flow 1200 then proceeds to block 1256, where the conversation thread in the SDN agent portal is closed, thereby preventing further messages from the brand agent, with the conversation removed from the list of active conversations (shown as a list 1002 in FIG. 10).

The SDN conversation management flow 1200 then proceeds to block 1254, where the conversation is archived in the SDN data warehouse of the SDN conversation system 110 for future access by the brand a 304 directly or for use in reporting and analytics.

In one embodiment, the SDN conversation management flow 1200 can proceed to block 1260, where the customer C 308 sends a follow-up SMS message after the conversation is closed. The SDN conversation system 110 receives the message in block 1262 where, depending on configuration, algorithms, and/or data from the brand A 304, the provider B 310, and the customer C 308, different actions may occur. In one embodiment, the SDN conversation system 110 may respond directly to the customer with an SMS message that the conversation is closed to suggest other follow-on action. In another embodiment, the SDN conversation system 110 may establish a new two-way conversation between the customer C 308 and the brand agents 302. In yet another embodiment, the SDN conversation system 110 may establish a new three-way conversation between the customer C 308, the brand agents 302, and the provider B310. In yet another embodiment, the SDN conversation system 110 may establish a new three-way conversation between the customer C 308, the brand agents 302, and a different provider based on predetermined provider selection algorithms and criteria.

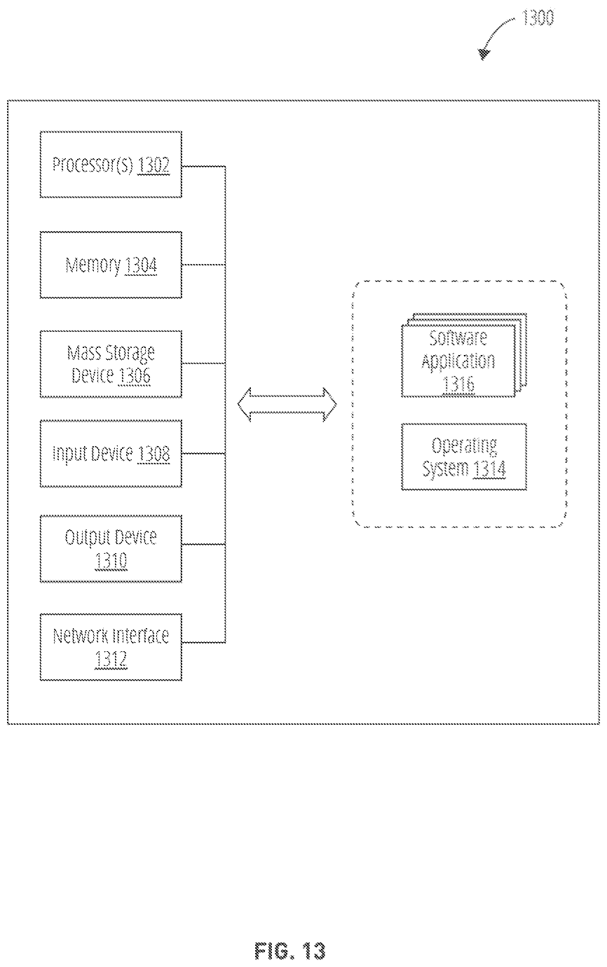

FIG. 13 is a high-level block diagram illustrating an example computer system 1300, within which a set of instructions for causing the machine to perform any one or more of the methodologies discussed herein can be executed. The computer system 1300 may include, refer to, or be an integral part of, one or more of a variety of types of devices, such as a general-purpose computer, a desktop computer, a laptop computer, a tablet computer, a netbook, a mobile phone, a smartphone, a personal digital computer, a smart television device, and a server, among others. In some embodiments, the computer system 1300 is an example of user devices of customers, user devices of providers, user devices of brand agents, or a system 110 shown in FIG. 2. Notably, FIG. 13 illustrates just one example of the computer system 1300 and, in some embodiments, the computer system 1300 may have fewer elements/modules than shown in FIG. 13 or more elements/modules than shown in FIG. 13.

The computer system 1300 may include one or more processor(s) 1302, a memory 1304, one or more mass storage devices 1306, one or more input devices 1308, one or more output devices 1310, and a network interface 1312. The processor(s) 1302 are, in some examples, configured to implement functionality and/or process instructions for execution within the computer system 1300. For example, the processor(s) 1302 may process instructions stored in the memory 1304 and/or instructions stored on the mass storage devices 1306. Such instructions may include components of an operating system 1314 or software applications 1316. The computer system 1300 may also include one or more additional components not shown in FIG. 13.

The memory 1304, according to one example, is configured to store information within the computer system 1300 during operation. The memory 1304, in some example embodiments, may refer to a non-transitory computer-readable storage medium or a computer-readable storage device. In some examples, the memory 1304 is a temporary memory, meaning that a primary purpose of the memory 1304 may not be long-term storage. The memory 1304 may also refer to a volatile memory, meaning that the memory 1304 does not maintain stored contents when the memory 1304 is not receiving power. Examples of volatile memories include random access memories (RAM), dynamic random access memories (DRAM), static random access memories (SRAM), and other forms of volatile memories known in the art. In some examples, the memory 1304 is used to store program instructions for execution by the processor(s) 1302. The memory 1304, in one example, is used by software (e.g., the operating system 1314 or the software applications 1316). Generally, the software applications 1316 refer to software applications suitable for implementing at least some operations of the methods for establishing communications between customers, brand agents and service providers within an SDN as described herein.

The mass storage devices 1306 may include one or more transitory or non-transitory computer-readable storage media and/or computer-readable storage devices. In some embodiments, the mass storage devices 1306 may be configured to store greater amounts of information than the memory 1304. The mass storage devices 1306 may further be configured for long-term storage of information. In some examples, the mass storage devices 1306 include non-volatile storage elements. Examples of such non-volatile storage elements include magnetic hard discs, optical discs, solid-state discs, flash memories, forms of electrically programmable memories (EPROM) or electrically erasable and programmable memories, and other forms of non-volatile memories known in the art.

The input devices 1308, in some examples, may be configured to receive input from a user through tactile, audio, video, or biometric channels. Examples of the input devices 1308 may include a keyboard, a keypad, a mouse, a trackball, a touchscreen, a touchpad, a microphone, one or more video cameras, image sensors, fingerprint sensors, or any other device capable of detecting an input from a user or other source, and relaying the input to the computer system 1300, or components thereof. In an example embodiment, the input may be received in the form of voice, which can be sensed and recorded via a virtual assistant application (e.g., Alexa®, Siri®, Google Assistant®) associated with the computer system 1300.

The output devices 1310, in some examples, may be configured to provide output to a user through visual or auditory channels. The output devices 1310 may include a video graphics adapter card, a liquid crystal display (LCD) monitor, a light emitting diode (LED) monitor, an organic LED monitor, a sound card, a speaker, a lighting device, a LED, a projector, or any other device capable of generating output that may be intelligible to a user. The output devices 1310 may also include a touchscreen, a presence-sensitive display, or other input/output capable displays known in the art.

The network interface 1312 of the computer system 1300, in some example embodiments, can be utilized to communicate with external devices via one or more data networks such as one or more wired, wireless, or optical networks including, for example, the Internet, intranet, LAN, WAN, cellular phone networks, Bluetooth radio, and an IEEE 902.11-based radio frequency network, Wi-Fi networks®, among others. The network interface 1312 may be a network interface card, such as an Ethernet card, an optical transceiver, a radio frequency transceiver, or any other type of device that can send and receive information.

The operating system 1314 may control one or more functionalities of the computer system 1300 and/or components thereof. For example, the operating system 1314 may interact with the software applications 1316 and may facilitate one or more interactions between the software applications 1316 and components of the computer system 1300. As shown in FIG. 13, the operating system 1314 may interact with or be otherwise coupled to the software applications 1316 and components thereof. In some embodiments, the software applications 1316 may be included in the operating system 1314. In these and other examples, virtual modules, firmware, or software may be part of the software applications 1316.

Thus, systems and methods for establishing at least three-way conversations between customers, service providers, and brand agents within an SDN have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A method for establishing an at least three-way conversation between customers, service providers, and brand agents within a service delivery network (SDN), the method comprising:
receiving, from a customer, a request for a service by a brand;
collecting metadata associated with the customer;
receiving identification data associated with a service provider, the service provider being selected by the brand based on at least the metadata;
initiating a two-way communication channel between the customer and one or more brand agents associated with the brand;
based on the identification data, providing a Uniform Resource Locator (URL) to the service provider to join the two-way communication channel; and
initiating the at least three-way conversation between the customer, the service provider, and the one or more brand agents via the two-way communication channel.

2. The method of claim 1, further comprising detecting opening of the URL by the service provider, wherein the initiation of the at least three-way conversation via the two-way communication channel is in response to the detection.

3. The method of claim 1, wherein the one or more brand agents communicating through the two-way communication channel include one or more of the following: one or more human agents, a bot agent, and a combination of the one or more human agents and the bot agent, wherein the one or more human agents and the bot agent are affiliated and controlled by the brand, the brand orchestrating the SDN.

4. The method of claim 1, further comprising, in response to the request, providing, through the two-way communication channel, an initial response to the customer regarding the service, the initial response prompting the customer to provide a part of the metadata.

5. The method of claim 4, wherein the initial response sent through the two-way communication channel is provided to the customer via a Short Message Service (SMS).

6. The method of claim 5, wherein the initial response and the messages sent via the SMS are communicated between a phone number of the customer and a single phone number provisioned for the brand.

7. The method of claim 1, further comprising enabling the one or more brand agents to communicate through the two-way communication channel via an application, the application enabling the one or more brand agents to monitor, review, and participate in conversations between the customer and the service provider.

8. The method of claim 1, wherein the metadata include one or more of the following: a name of the customer, a phone number of the customer, a price associated with the service, an identifier associated with the request, a location of the customer, and information provided by the customer.

9. The method of claim 1, wherein the selection of the service provider includes one of the following:
selecting the service provider from a plurality of service providers associated with the SDN; and
selecting a predetermined service provider associated with the customer, the predetermined service provider including the service provider.

10. The method of claim 1, wherein the two-way communication channel is initiated by sending an Application Programming Interface (API) call, the API call including the metadata associated with the customer and identifying the service provider.

11. The method of claim 1, wherein the providing the URL to the service provider includes sending, via a messaging mechanism, a message including the URL and the metadata to the service provider.

12. The method of claim 11, wherein the messaging mechanism includes one of the following: an SMS, an email, a messaging application, and a social media.

13. The method of claim 1, wherein the URL is embedded in a third-party application, wherein the third-party application includes one of the following: a first third-party application provided by the brand to the service provider and a second third-party application used by the service provider, the second third-party application not being associated with the brand.

14. The method of claim 1, wherein the URL is associated with a web-based user interface, the web-based user interface enabling the service provider to send messages to and receive messages from the customer and the one or more brand agents.

15. The method of claim 1, further comprising enabling the one or more brand agents to:
allow one or more service providers of a plurality of service providers to join the two-way communication channel; and
force the one or more service providers to leave the two-way communication channel.

16. The method of claim 1, further comprising enabling the one or more brand agents to:
permit or forbid sharing of a phone number of the customer and contact information of the customer with the service provider; and
permit or forbid sharing of a phone number of the service provider and contact information of the service provider with the customer.

17. The method of claim 1, further comprising enabling the one or more brand agents to allow the customer to participate in multiple simultaneous conversations with one or more service providers of a plurality service provider via an SMS, the allowing includes:
provisioning an individual phone number for each of the one or more service providers; and
controlling, by the one or more brand agents, each of the multiple simultaneous conversations.

18. A system for establishing an at least three-way conversation between customers, service provider, and brand agents within a service delivery network (SDN), the system comprising:
a processor; and
a memory storing instructions that, when executed by the processor, command the processor to:
receive, from a customer, a request for a service by a brand;
collect metadata associated with the customer;
receive identification data associated with a service provider, the service provider being selected by the brand based on at least the metadata;
initiate a two-way communication channel between the customer and one or more brand agents associated with the brand;
based on the identification data, provide a Uniform Resource Locator (URL) to the service provider to join the two-way communication channel; and
initiate the at least three-way conversation between the customer, the service provider, and the one or more brand agents via the two-way communication channel.

19. The system of claim 18, wherein the processor is further configured to detect opening of the URL by the service provider, the initiating of the three-way conversation via the two-way communication channel being based on the detection.

20. The system of claim 18, wherein the one or more brand agents communicating through the two-way communication channel include one of the following: one or more human agents, a bot agent, and a combination of the one or more human agents and the bot agent, wherein the one or more human agents and the bot agent are affiliated and controlled by the brand, the brand orchestrating the SDN.

21. The system of claim 18, wherein the processor is further configured to, in response to the request, provide, through the two-way communication channel, an initial response to the customer regarding the service, the initial response prompting the customer to provide a part of the metadata.

22. The system of claim 18, wherein the processor is further configured to enable the one or more brand agents to communicate through the two-way communication channel via an application, the application enabling the one or more brand agents to monitor, review, and participate in conversations between the customer and the service provider.

23. The system of claim 18, wherein the processor is further configured to enable the one or more brand agents to:
allow one or more service providers of a plurality of service providers to join the two-way communication channel; and
force the one or more service providers to leave the two-way communication channel.

24. A non-transitory computer-readable storage medium, the non-transitory computer-readable storage medium including instructions that, when executed by a processor, cause the processor to:
receive, from a customer, a request for a service by a brand;
collect metadata associated with the customer;
receive identification data associated with a service provider, the service provider being selected by the brand based on at least the metadata;
initiate a two-way communication channel between the customer and one or more brand agents associated with the brand;
based on the identification data, provide a Uniform Resource Locator (URL) to the service provider to join the two-way communication channel; and
initiate an at least three-way conversation between the customer, the service provider, and the one or more brand agents via the two-way communication channel.
